(19) United States
(12) Patent Application Publication
(10) Pub. No.: US 2010/0265281 A1
(43) Pub. Date: Oct. 21, 2010

(54) IMAGE DISPLAY DEVICE

(76) Inventors: Norimasa FURUKAWA, Tokyo (JP); Mitsuyasu Asano, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/756,831

(22) Filed: Apr. 8, 2010

(30) Foreign Application Priority Data
Apr. 15, 2009 (JP) P2009-099177

(51) Int. Cl. G09G 5/10

(52) U.S. Cl. 345/691

(57) ABSTRACT

The image display device includes a light source section having light emitting subsections; a display panel; and a display control section performing a control. An input frame image is decomposed into a plurality of field images and the field images are displayed in a field sequential manner. A differential image for each of the three primary-color components is obtained by subtracting a common luminance portion from the subsection-drive frame image. The differential image and a common image configured of the common luminance portion are sequentially outputted to the display panel in a time-divisional manner. In the first field period for outputting the differential image of a primary color component, corresponding primary color light is emitted, and in a second field period for outputting the common image, multiple kinds of primary color light, corresponding to the primary-color components configuring the common luminance portion, are emitted together.

### BACKGROUND OF THE INVENTION

1. Field of the Invention

The present invention relates to an image display device performing color image display by a field sequential method.

2. Description of Related Art

A color image display method is roughly divided into two methods depending on additive color mixture methods. A first method depends on additive color mixture based on a spatial color mixture principle. More specifically, respective sub pixels of three primary-colors R (red), G (green), and B (blue) of light are finely arranged in a plane so that respective color light are indiscriminative in terms of spatial resolution of human eyes, thereby the colors are mixed in one screen to obtain a color image. The first method is applied to most of currently commercialized display types such as a cathode-ray tube type, a PDP (Plasma Display) type, and a liquid crystal type. When the first method is used to configure a display device of a type where light from a light source (backlight) is modulated to perform image display, for example, configure a display device using elements as modulating elements, the elements being not self-luminous as typified by a liquid crystal element, the following difficulties occur. That is, three systems of drive circuits are necessary in correspondence to respective RGB colors for driving the sub pixels in one screen. Moreover, RGB color filters are necessary. Furthermore, existence of the color filters decreases use efficiency of light to ⅓ because of absorption of light from a light source by the color filters.

A second method depends on additive color mixture using temporal color mixture. More specifically, the RGB three primary-colors of light are divided along a time axis, and planar images of the respective primary-colors are sequentially displayed with time (time-sequential). In addition, each screen is changed at a rate too high for human eyes to recognize the screen in terms of temporal resolution of human eyes so that each color light is indiscriminative due to temporal color mixture based on a storage effect in a temporal direction of eyes, and consequently a color image is displayed using temporal color mixture. The method is usually called field sequential method.

The second method is used to configure a display device using modulating elements being not self-luminous as typified by, for example, liquid crystal elements, which gives the following advantage. That is, since a state where a screen color is monochrome at each moment is obtained, spatial color filters for discriminating colors for each pixel in a plane are unnecessary. Also, light from a light source is changed into monochrome light for a black-and-white display screen, and each screen is changed at a rate too high to recognize the screen. Then, since a display image may be sequentially changed according to an R signal, a G signal, and a B signal in conjunction with changing back light given by a storage effect in a temporal direction of eyes into, for example, each monochrome of RGB, one drive circuit system is sufficient.

Furthermore, color selection is performed by temporally changing a color, and color filters are unnecessary as described before, leading to an effect of reducing passing loss of the quantity of light. Therefore, the second method is currently mainly used for a modulation method of a high-luminance, high-heat light source such as a projector (projection display method) in which reduction in the quantity of light tends to cause critical heat loss. Also, the second method is variously investigated because of its merit of high use efficiency of light.

However, the second method has a serious drawback in a visual sense. Specifically, a basic principle of display of the second method is that each screen is changed at a rate too high for human eyes to recognize the screen by utilizing the temporal resolution of human eyes. However, RGB images being time-sequentially displayed are not well mixed due to complicated factors including limitation in optic nerves of an eye ball, and an image recognition sense of a human brain. As a result, when an image having low color purity such as a white image is displayed, or when tracking view is performed to a display object moving within a screen, each primary color image is sometimes viewed as a residual image or the like, causing a display phenomenon of color breaking giving extreme discomfort to a viewer.

Such color breaking phenomena are roughly divided into two types. A first type is a color breaking phenomenon during displaying a still image, and a second type is a color breaking phenomenon during tracking view of a moving image.

The color breaking phenomenon during displaying a still image occurs even if an image is subjected to fixed-point staring in the case that a color image (still image) is decomposed into several monochrome images and the monochrome images are line-sequentially displayed. In this case, the color breaking phenomenon is perceived based on a relationship between response of a cone of an optic nerve on a retina and a display rate (frequency) the decomposed, several monochrome images.

In contrast, the color breaking phenomenon during tracking view occurs due to a fact that when tracking view of a moving object is performed, since a display color is in a primary color field configuration of RGB, even if spatial display positions are the same between display time points of respective primary-color images, eyes predict a position of the object after movement and thus move ahead. That is, each image is apparently formed on a retina while being displaced from a stationary position, and thus the image is perceived to be displaced. It is considered to hardly cope with the phenomenon unless a display rate is increased to about 1 KHz.

Incidentally, what rate of field frequency is desirable will be studied here with an example where a difficulty in gradation display, rather than the color breaking phenomenon, occurs in luminance superimposing. Plasma display is an appropriate example among existing display types. Plasma display employs a sub-frame frequency of 720 Hz being approximately 12 times as high as 60 Hz. It is known that luminance is not well superimposed for gradation representation during observing a moving image based on the above principle, leading to annual-ring-like visual interference called false contour of a moving image.

Thus, various measures for overcoming the drawback (color breaking phenomenon) of the second method have been proposed in the past. For example, a drive method is proposed, in which color sequential drive is performed without color filters, and frames of white display are inserted to prevent color breaking so as to achieve continuous spectral energy stimulus on a retina, leading to reduction in color breaking.

As such a technique in the past, for example, a technique is known, in which a field for mixing a white light component period is provided in each field of the RGB field sequential, thereby reduction in color breaking is achieved (for example, see Japanese Unexamined Patent Application, Publication No. 2008-020758). As another technique in the past, a technique is known, in which a white component is extracted, and a W (white) field is additionally provided between RGBRGB sequence to insert the white component, so that 4-sequential frames of RGBWRGBW are formed so as to prevent color breaking (for example, see Japanese Patent No. 3912999). Moreover, a technique is known, in which image information is extracted, and color origin coordinates of each primary color (basic color) itself to be processed are changed, so that color breaking is prevented (for example, see Japanese Patent No. 3878030). In addition, various proposals have been made for improving display by the field sequential method (see Japanese Unexamined Patent Application, Publication Nos. 2008-310286 and 2007-264211, Published Japanese Translation of PCT Application No. 2008-510347, and Japanese Patent No. 3977675).

### SUMMARY OF THE INVENTION

The technique described in Japanese Unexamined Patent Application, Publication No. 2008-020758 has a difficulty that if a display image region having high color purity exists in a display screen, mixing of white light occurs, which degrades color purity of a display region, so that a correct color is hardly reproduced. Also, if color breaking is intended to be reduced while keeping color purity, for example, it is estimated that subfield frequency be increased to 180 Hz or more. That is, considerably high field frequency is necessary for increasing the number of frames in order to reduce color breaking to a detection limit or lower. In at least response capability of a liquid crystal panel at present, even if drive frequency of 360 Hz is achieved by using high-speed liquid crystal, since a 4-field cycle of RGBW is given by inserting white, frequency of each color is decreased to ¼, 90 Hz. Such frequency is not high enough to fully reduce color breaking. While the frequency of 360 Hz is achieved by using DMD or the like in a projection-type projector other than the liquid crystal type, color breaking may still not be reduced to a detection limit or lower at the frequency.

In the technique described in Japanese Patent No. 3912999, frequency of occurrence of W field is ¼ of field frequency, leading to a slight effect of preventing color breaking. On the other hand, when concurrent lighting is performed within a field as in the technique described in Japanese Unexamined Patent Application, Publication No. 2008-020758, color purity is degraded.

In the technique described in Japanese Patent No. 3878030, when a case is considered as an example where an image portion having high color saturation such as a primary color portion partially exists in a screen, basic colors need to be not changed from original colors in order to keep color purity of the portion. Therefore, color breaking occurs in a black-and-white portion being another portion in the screen because RGB is divided along a time axis. Therefore, ensuring of partial color purity and prevention of color breaking are not achieved together.

In the technique described in Japanese Unexamined Patent Application, Publication No. 2008-310286, when a portion having high purity of a saturated color does not exist in an image, the image is defined as a mild image. In such a case, a white component is lit over the whole surface through color mixing by a backlight, so that color breaking is prevented. In this technique, colored image portions having high color saturation other than the mild image are studded in one image plane. Thus, existence of the portions having high color saturation in a screen causes reduction in chroma by lighting over the whole surface through color mixing. Therefore, ensuring of partial color purity and prevention of color breaking are not achieved together.

In addition, since modulation may not be performed in a space, various techniques of reducing color breaking have been studied utilizing various kinds of processing on a time axis in order to prevent color breaking while removing color filters. However, since surface-sequential images, which are completely separated into RGB, have no cross-field correlation in color one another, color breaking occurs in the present situation. Consequently, color breaking has been effectively prevented only by means of mixing white at the sacrifice of color purity, and compensating little cross-frame correlation by increasing field frequency, for example, increasing field frequency to insert white frames.

Furthermore, Japanese Unexamined Patent Application, Publication No. 2007-264211 describes luminance on a retina while using various space-time diagrams and various retina diagrams. Moreover, it is described that color breaking is decreased by using a configuration of RGBKKK with K as a black screen. In this disclosure, a figure showing luminance distribution on a retina is depicted to be a center-symmetric trapezoidal shape even though an objective image is decomposed into integrated RGB images having different luminance. However, since a composition object is a primary color image rather than a black-and-white image having a uniform luminance component, lateral luminance along an eye-tracking reference on a retina is actually not shaped to be center-symmetric unlike the figure. That is, the figure lacks preciseness. In reality, such luminance distribution should be insufficiently balanced in luminance. As a result, in the technique described in JP2007-264211A, color difference and luminance difference occurring between the front and the back in an image movement direction are visually perceived as shift in color and luminance, and therefore effectiveness is small compared with a display method described later as proposed by this application.

The technique in the past described in Published Japanese Translation of PCT Application No. 2008-510347 is a proposal where a measure is taken in such a manner that a movement portion of a picture signal is detected, and a display picture side is displayed while being shifted in a movement direction in advance for the purpose of correcting shift in image on a retina occurring in moving-image tracking view. The method is effective in a period where tracking view is performed to the relevant portion. However, whether or not to perform the tracking view is a matter of subjective determination of an observer. Therefore, the technique has a serious drawback that color breaking is perceived in a further degraded sense due to processing of displacing even a picture being originally not displaced, such as a picture being fixedly viewed, or a picture concurrently showing multiple objects moving in different directions, and consequently the technique is hard to be practically used.

Japanese Patent No. 3977675 proposes to distribute RGBYeMgCy at the sixfold speed. This proposal lacks the concept of a luminance center with respect to eye tracking.

As hereinbefore, while various proposals have been made to suppress color breaking in the past, any of proposals may still not sufficiently suppress color breaking and therefore there is room for improvement.

It is desirable to provide an image display device, capable of suppressing color breaking occurring in the field sequential method.

An image display device according to an embodiment of the invention includes: a light source section having a plurality of light emitting subsections configured to be controlled independently of each other, each of the light emitting subsections emitting multiple kinds of color light; a display panel modulating color light emitted from the light source section based on an input picture signal; and a display control section controlling the light emitting subsections of the light source section and the display panel, so that an input frame image configured of the input picture signal is decomposed into a plurality of field images, and so that the plurality of field images are time-divisionally displayed in a field sequential manner, wherein the display control section includes a subsection-drive processing section applying a predetermined resolution-lowering process on the input picture signal, thereby generating a light emission pattern based on a result of the resolution-lowering process, the light emission pattern being to be formed through selective light emitting operations of the plurality of light emitting subsections of the light source section, and then the subsection-drive processing section performing a dividing operation in which a signal level of each pixel signal in the input picture signal is divided by an emission-level of corresponding light emitting subsection in the light emission pattern, thereby generating a subsection-drive picture signal as a result of the dividing operation, a signal analysis section analyzing color components of a subsection-drive frame image configured of the subsection-drive picture signal, to extract a first common luminance portion from the subsection-drive frame image, the first common luminance portion having a luminance magnitude common to two or more of three primary-color components configured of red, green, and blue components, a signal output section obtaining a first differential image for each of the three primary-color components by subtracting the first common luminance portion from the subsection-drive frame image, and sequentially outputting, as the plurality of field images, the first differential images for the primary-color components and a first common image which is configured of the first common luminance portion to the display panel in a time-divisional manner, and a color light selection section selecting color light to be emitted from the light source section based on the light emission pattern and the first common image, so that, in each of first field periods where the first differential images for the primary color components are outputted respectively, only corresponding primary color light is emitted, and in a second field period where the first common image is outputted, multiple kinds of primary color light, corresponding to the two or more primary-color components which configure the first common luminance portion, are emitted together.

In the image display device according to the embodiment of the invention, the display panel modulates the color light emitted from the light source section, leading to image display based on the input picture signals. At this time, the display control is performed to the light emitting subsections of the light source section and the display panel, so that the input frame image is decomposed into the plurality of field images, and so that the plurality of field images are time-divisionally displayed in the field sequential manner. In such display control, the predetermined resolution-lowering process is first performed on the input picture signal, and thereby the light emission pattern is generated based on the result of the resolution-lowering process, in which the light emission pattern is to be formed through the selective light emitting operations of the plurality of light emitting subsections of the light source section, and then the dividing operation is performed in which the signal level of each pixel signal in the input picture signal is divided by the emission-level of the corresponding light emitting subsection in the light emission pattern, thereby generating the subsection-drive picture signal as a result of the dividing operation. Then, the color components of the subsection-drive frame image configured of the subsection-drive picture signal are analyzed, to extract the first common luminance portion from the subsection-drive frame image, in which the first common luminance portion has the luminance magnitude common to two or more of three primary-color components configured of red, green, and blue components. Then, the first differential image is obtained for each of the three primary-color components by subtracting the first common luminance portion from the subsection-drive frame image, and the first differential images for the primary-color components and the first common image which is configured of the first common luminance portion are sequentially outputted as the plurality of field images to the display panel in a time-divisional manner. In addition, the color light to be emitted from the light source section is selected based on the light emission pattern and the first common image, so that, in each of the first field periods where the first differential images for the primary color components are outputted respectively, only the corresponding primary color light is emitted, and in the second field period where the first common image is outputted, the multiple kinds of primary color light, corresponding to the two or more primary-color components which configure the first common luminance portion, are emitted together. In this way, in the second field period where the first common image is outputted, the multiple kinds of primary color light are emitted together so that multi-primary color display is performed, and any of the primary color light is emitted from the light source section having low resolution (rough resolution corresponding to the number of subsections) compared with display pixels, and thereby the multi-primary color display is performed with low resolution in the second field period. In the first field period, the first differential image obtained by subtracting the first common luminance portion from the subsection-drive frame image is selectively outputted, and only the corresponding primary color light is emitted from the light source section. Thus, a luminance distribution of a display image along a time axis within a frame period tends to be concentrated in the second field period where the first common image is selectively outputted.

In the image display device according to the embodiment of the invention, advantageously, the signal analysis section analyzes color components of the input frame image, thereby obtains a signal level of each of a plurality of color component images which are obtained through decomposing the input frame image into a plurality of color components, the display control section further includes a fundamental-image determination section calculating a luminance level with consideration of a visibility characteristic for each of the color component images based on a signal level of each of the color component images obtained by the signal analysis section, and then determining a color component image, having the highest luminance level or the second highest luminance level, as a fundamental image, the signal output section further performs processes of obtaining a second differential image for each of the plurality of color components by subtracting the fundamental image from the subsection-drive frame image, halving the second differential image obtained for each of the color components, and then sequentially outputting halved images for each of the color components as well as the fundamental image, as the plurality of field images, to the display panel in a time-divisional manner, and the display control section further includes an output sequence determination section controlling output sequence in a frame of the plurality of field images outputted from the signal output section so that the fundamental image is displayed in a temporally central position within a frame period, and so that the halved images are displayed before and after the fundamental image in such a manner that a halved image having a higher luminance level with consideration of the visibility characteristic is located closer to the fundamental image.

In such a configuration, the color component image having the relatively high luminance level is extracted as the fundamental image from the input image. Also, the second differential image for each of the plurality of color components is obtained by subtracting the fundamental image from the subsection-drive frame image, the second differential image obtained for each of the color components is halved, and then the halved images for each of the color components as well as the fundamental image are sequentially outputted, as the plurality of field images, to the display panel in a time-divisional manner. At this time, the output sequence in a frame of the plurality of field images outputted from the signal output section is controlled, so that the fundamental image is displayed in a temporally central position within a frame period. Also, the output sequence is controlled, so that the halved images are displayed before and after the fundamental image in such a manner that the halved image having the higher luminance level with consideration of the visibility characteristic is located closer to the fundamental image. Thus, an image having a color component being bright and high in visibility is displayed in a temporally central position within a frame period, and images having other color components respectively are displayed temporally symmetrically in order of a higher luminance level. Accordingly, a shape of luminance distribution on a retina is made high in the center and symmetric, leading to further suppression of color breaking occurring in tracking view of a moving image by the field sequential method.

According to the image display device of the embodiment of the invention, in the second field period where the first common image is outputted, the multiple kinds of primary color light are emitted together so that multi-primary color display is performed, and any of the primary color light is emitted from the light source section having low resolution (rough resolution corresponding to the number of subsections) compared with display pixels. Accordingly, the multi-primary color display is performed with low resolution in the second field period. In addition, in the first field period, the first differential image obtained by subtracting the first common luminance portion from the subsection-drive frame image is selectively outputted, and only the corresponding primary color light is emitted from the light source section. Therefore, it is possible to concentrate the luminance distribution of a display image, along a time axis within a frame period, in the second field period where the first common image is selectively outputted. Therefore, the color breaking occurring in the field sequential method is suppressed, leading to improvement in image quality in color display.

Other and further objects, features and advantages of the invention will appear more fully from the following description.

### BRIEF DESCRIPTION OF THE DRAWINGS

FIG. 1 is a block diagram showing a configuration example of an image display device according to a first embodiment of the invention.

FIG. 2 is an exploded perspective diagram schematically showing an example of each of a light emitting subsection and an irradiation subsection.

FIGS. 3A and 3B are explanatory diagrams schematically showing a concept of extracting a common white component Wcom from color picture signals of R, G, and B.

FIG. 4 is an explanatory diagram showing a superimposing relationship of luminance images by using a backlight and a display panel.

FIG. 5 is an explanatory diagram of display operation of the image display device shown in FIG. 1.

FIG. 6 is a block diagram showing a configuration example of an image display device according to a second embodiment of the invention.

FIG. 7 is an explanatory diagram schematically showing a first method of extracting a common yellow component Yecom from color picture signals of R, G, and B.

FIG. 8 is an explanatory diagram schematically showing a second method of extracting the common yellow component Yecom from color picture signals of R, G, and B.

FIG. 9 is another explanatory diagram of display operation of the image display device shown in FIG. 1.

FIG. 10 is a block diagram showing a configuration example of an image display device according to a modification (modification 1) of the second embodiment.

FIG. 11 is a block diagram showing a configuration example of an image display device according to a third embodiment of the invention.

FIG. 12 is an explanatory diagram schematically showing image display by a field sequential method.

FIG. 13 is an explanatory diagram schematically showing a display state in the case that a moving object is displayed while decomposing a frame image into field images of three colors in order of R, G, and B by the field sequential method, and also schematically showing luminance distribution on a retina.

FIG. 14 is an explanatory diagram of color breaking occurring in the field sequential method.

FIG. 15 is an explanatory diagram more precisely showing luminance distribution on a retina in the display state shown in FIG. 13.

FIG. 16 is an explanatory diagram schematically showing a display state in the case that a moving object is displayed while decomposing a frame image into four field images of four colors in order of R, G, B, and W by the field sequential method.

FIG. 17 is an explanatory diagram more precisely showing the display state shown in FIG. 16.

FIG. 18 is an explanatory diagram schematically showing luminance distribution on a retina in the display state shown in FIG. 16.

FIG. 19 is an explanatory diagram schematically showing luminance distribution on a retina in the case that display order of R, G, and B is changed from that in the display state shown in FIG. 16.

FIG. 20 is an explanatory diagram schematically showing a relationship between display order of colors and distribution of the quantity of light.

FIG. 21 is an explanatory diagram showing an example of an image display method according to a third embodiment, which schematically shows a display state in the case that color components being bright and high in visibility are symmetrically arranged within a frame period with the common white component Wcom as a field center.

FIG. 22 is an explanatory diagram schematically showing luminance distribution on a retina in the display state shown in FIG. 21.

FIG. 23 is a block diagram showing a configuration example of an image display device according to a modification (modification 2) of the third embodiment.

FIG. 24 is an explanatory diagram showing an example of an image display method according to the modification 2, which schematically shows a display state in the case that color components being bright and high in visibility are symmetrically arranged within a frame period with a common yellow component Yecom as a field center.

FIG. 25 is an explanatory diagram schematically showing luminance distribution on a retina in the display state shown in FIG. 24.

FIG. 26 is an explanatory diagram showing an example of an image display method according to another modification (modification 3) of the third embodiment, which schematically shows a display state in the case that color components being bright and high in visibility are symmetrically arranged within a frame period with a common magenta component Mgcom as a field center.

FIG. 27 is a flowchart showing an example of a method of determining a color component to be disposed in a field center according to another modification (modification 4) of the third embodiment.

FIG. 28 is an explanatory diagram showing a specific example of a signal level of each color component, and a luminance level calculated based on the signal level.

FIG. 29 is an explanatory diagram showing a concept of calculating a luminance level of each color component from an original image.

FIG. 30 is an explanatory diagram showing a method of reducing the number of fields within a frame period according to another modification (modification 5) of the third embodiment.

FIG. 31 is an explanatory diagram showing a human visibility characteristic in a bright place according to another modification (modification 6) of the third embodiment.

FIG. 32 is an explanatory diagram showing a human visibility characteristic in a dark place according to the modification 6.

FIG. 33 is an explanatory diagram showing a visibility characteristic of a color deviant according to the modification 6.

FIG. 34 is an explanatory diagram showing a wavelength discriminating characteristic of a color deviant according to the modification 6.

### DETAILED DESCRIPTION OF THE PREFERRED EMBODIMENTS

Hereinafter, preferred embodiments of the invention will be described in detail with reference to drawings. The description will be made in the following sequence.

1. First embodiment (method of reducing color breaking by subsection-drive of a light source by using Wcom)

2. Second embodiment (method of reducing color breaking by subsection-drive of a light source by using Yecom)
Modification 1 (example of a case where subsection-drive of a light source is not performed only in blue display)

3. Third embodiment (method of reducing color breaking by luminance balance and subsection-drive by using Wcom)
Modification 2 (method of reducing color breaking by luminance balance and subsection-drive by using Yecom)
Modification 3 (method of reducing color breaking by luminance balance and subsection-drive by using Mgcom)
Modification 4 (example of a method of determining a color component disposed in a field center)
Modification 5 (example of a method of reducing the field number within a frame period)
Modification 6 (example of a display method in the case of performing visibility correction)

### 1. First Embodiment

### [General Configuration of Image Display Device 5]

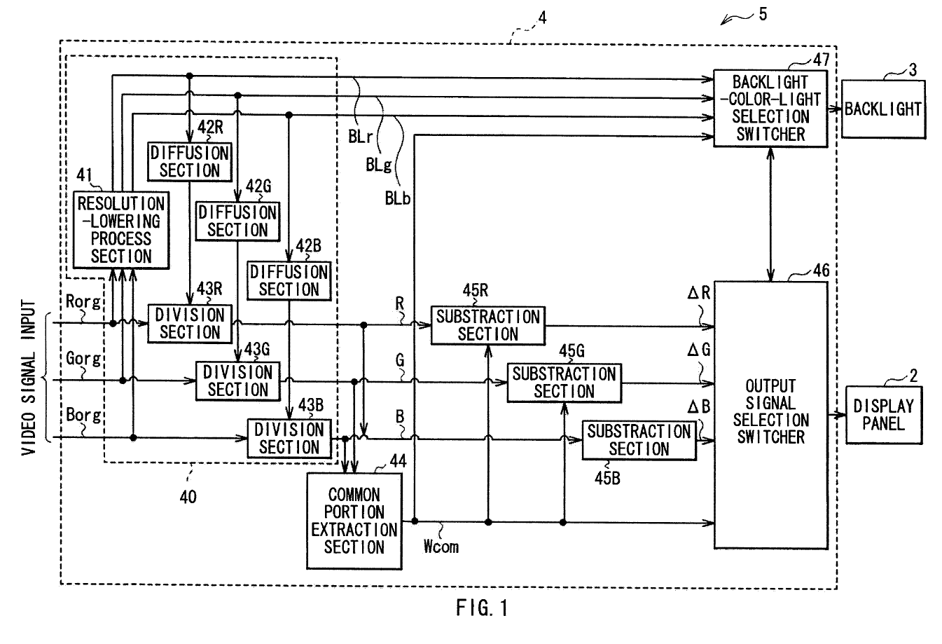

FIG. 1 shows a configuration example of an image display device 5 according to a first embodiment. The image display device has a display control section 4 to be inputted with RGB picture signals (original signals Rorg, Gorg, and Borg) showing an input image. Moreover, the device has a display panel 2 that is controlled by the display control section 4, and performs color image display by the field sequential method, and has a backlight 3.

The display panel 2 performs image display in synchronization with each color light emission of the backlight 3. The display panel 2 time-divisionally displays a plurality of field images by the field sequential method according to display order based on control by the display control section 4. The display panel 2 includes, for example, a transmissive liquid crystal panel performing image display by controlling light, which is irradiated (emitted) from the backlight 3 and passes through liquid crystal molecules, by using the liquid crystal molecules. In such a liquid crystal panel, color light irradiated from the backlight 3 is modulated based on a picture signal. A plurality of display pixels (not shown) are regularly two-dimensionally arranged on a display surface of the display panel 2.

The backlight 3 is a light source section that time-divisionally emits multiple kinds of color light necessary for color image display for each color light. The backlight 3 is driven to emit light in accordance with an input picture signal according to control by the display control section 4. The backlight 3 is, for example, disposed on a back side of the display panel 2 so as to irradiate the display panel 2 from the back side. The backlight 3 may be formed using, for example, LED (Light Emitting Diodes) as light emitting elements (light source). The backlight 3 is configured, for example, by two-dimensionally arranging a plurality of LEDs in a plane so that multiple kinds of color light are independently surface-emitted. However, the light emitting elements are not limited to LED. The backlight 3 is, for example, configured of a combination of at least red LED emitting red light, green LED emitting green light, and blue LED emitting blue light. The backlight 3 is controlled by the display control section 4 so that each color LED independently emits light (is turned on) for primary color light emission, or respective kinds of color light are additively mixed for achromatic-color (black-and-white) light emission or complementary color light emission. As used herein, the achromatic color refers to black, gray or white having only brightness among hue, brightness and chroma being three attributes of color. The backlight 3 performs, for example, light emission of yellow being one of complementary colors by turning off blue LED, and turning on red LED and green LED. Moreover, respective color LED are appropriately adjusted in quantity of emission light so as to concurrently emit light with appropriate color balance, and the backlight 3 thereby performs light emission of any color other than complementary colors and white.

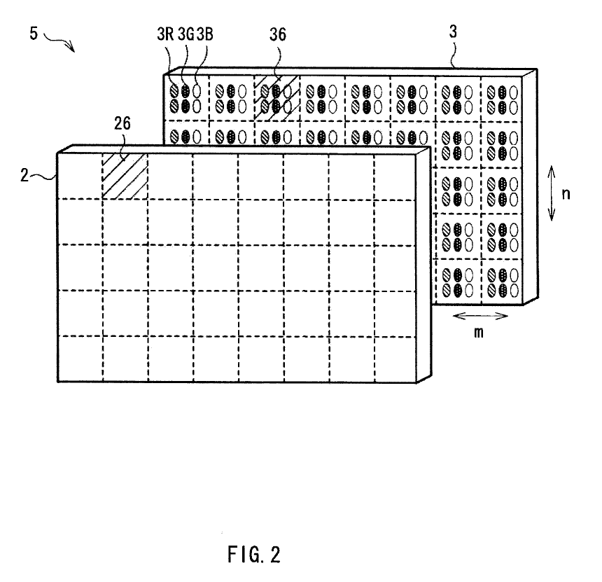

The backlight 3 further has a plurality of light emitting subsections 36 configured such that the areas are independently controlled, and multiple kinds of color light are separately emitted, for example, as shown in FIG. 2. That is, the backlight 3 is a subsection-drive backlight. Specifically, in the backlight 3, a plurality of light sources are two-dimensionally arranged so that the plurality of light emitting subsections 36 are provided. Thus, the light source section 3 has a light-emitting area being divided into column n*row m=K (n or m is an integer not less than 2) in an in-plane direction. The division number is low in resolution compared with display pixels. In the display panel 2, a plurality of irradiation subsections 26 are formed in correspondence to the light emitting subsections 36 respectively. The light source section 3 is independently controllable in light emission for each of the light emitting subsections 36 in accordance with input picture signals (original signals Rorg, Gorg, and Borg). In the present embodiment, the light source is configured by combining respective color LEDs of red LED 3R emitting red light, green LED 3G emitting green light, and blue LED 3B emitting blue light, and emits multiple kinds of color light through additive color mixture of the respective color light. Such a light source is disposed by at least one in each of the light emitting subsections 36.

### [Detailed Configuration of Display Control Section 4]

The display control section 4 decomposes an input image expressed by picture signals of R, G, and B into a plurality of field images in frames, and performs display control such that the field images are time-divisionally displayed by the field sequential method. Specifically, the display control section performs such display control to each of the light emitting subsections 36 of the backlight 3 and the display panel 2. The display control section 4 has a subsection-drive processing section 40, a common portion extraction section 44, subtraction sections 45R, 45G, and 45B, an output signal selection switcher 46, and a backlight-color-light selection switcher 47.

In the present embodiment, the backlight 3 corresponds to an example of the “light source section” of the invention, and the light emitting subsections 36 correspond to an example of the “light emitting subsections” of the invention. The common portion extraction section 44 corresponds to an example of the “signal analysis section” of the invention. The subtraction sections 45R, 45G, and 45B and the output signal selection switcher 46 correspond to an example of the “signal output section” of the invention. The backlight-color-light selection switcher 47 corresponds to an example of the “color light selection section” of the invention.

The subsection-drive processing section 40 performs predetermined subsection-drive processing, which will be described hereinafter, to each of the input picture signals (original signals Rorg, Gorg, and Borg), and thereby generates subsection-drive signals R, G, and B for each of primary color components. The subsection-drive processing section 40 has a resolution-lowering process section 41, diffusion sections 42R, 42G, and 42B, and division sections 43R, 43G, and 43B.

The resolution-lowering process section 41 performs predetermined resolution-lowering process to each of the original signals Rorg, Gorg, and Borg, and thereby generates light emission patterns BLr, BLg, and BLb for each of the light emitting subsections 36 of the backlight 3. Each of levels of the light emission patterns BLr, BLg, and BLb is obtained by analyzing levels of the original signals Rorg, Gorg, and Borg for respective display pixels of the display panel 2 in irradiation subsections 26 (light emitting subsections 36) respectively. Specifically, for example, the signal level is obtained by obtaining a maximum value or the like in the relevant area by using a predetermined rule. The rule is a technique belonging to a light emission luminance determination algorithm, and thus description thereof will not be given here since it does not directly relate to the application.

The diffusion sections 42R, 42G, and 42B perform predetermined diffusion processing to the light emission patterns BLr, BLg, and BLb outputted from the resolution-lowering process section 41, and outputs the light emission patterns BLr, BLg, and BLb subjected to the diffusion processing to the division sections 43R, 43G, and 43B, respectively.

The division sections 43R, 43G, and 43B divide the signal levels of the original signals Rorg, Gorg, and Borg by signal levels of the light emission patterns BLr, BLg, and BLb which are subjected to the diffusion processing and outputted from the diffusion sections 42R, 42G, and 42B, and thereby generate subsection-drive picture signals R, G, and B, respectively. Specifically, the division sections 43R, 43G, and 43B generate the subsection-drive picture signals R, G, and B by using the following formulas (1) to (3), respectively.

R=(Rorg/BLr) (1)

G=(Gorg/BLg) (2)

B=(Borg/BLb) (3)

From the formulas (1) to (3), a relationship of original signal=(light emission pattern*subsection-drive picture signal) is obtained. Physical meaning of (light emission pattern*subsection-drive picture signal) is that an image of the light emitting subsections 36 of the backlight 3, which has been turned on with a certain light emission pattern, is superimposed with an image of subsection-drive picture signals. This cancels brightness distribution of transmitted light through the display panel 2, leading to display equivalent to original display (display using original signals).

The common portion extraction section 44 analyzes color components of subsection-drive images configured of the subsection-drive picture signals R, G, and B respectively. Thus, a common portion (hereinafter referred to as a “common color component”) is extracted from the subsection-drive images, the common color component being an optional color component common to at least two primary-color components of the three primary-color components of the red (R) component, the green (G) component, and the blue (B) component. Specifically, in the present embodiment, a white component (common white component Wcom) common to all the three primary-color components is extracted from the subsection-drive images.

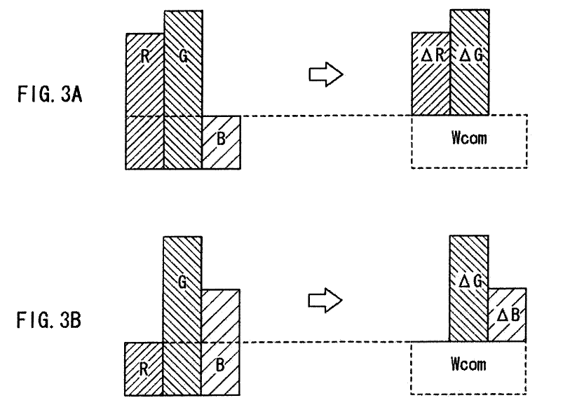

FIGS. 3A and 3B show an example of separation and extraction of the common white component Wcom. FIG. 3A shows an example of separating and extracting the common white component Wcom in accordance with a level of the subsection-drive picture signal B of the blue component, and FIG. 3B shows an example of separating and extracting the common white component Wcom in accordance with a level of the subsection-drive picture signal R of the red component. In the case of FIG. 3A, a differential image after extracting the common white component Wcom has a red component ΔR and a green component ΔG described later. In the case of FIG. 3B, a differential image has a blue component ΔB and the green component ΔG described later. That is, a color component W of an original image configured of original signals is expressed as the following formula (4) using the common white component Wcom, the red differential ΔR, the blue differential ΔB, and the green differential ΔG.

W=Wcom+ΔR+ΔB+ΔG (4)

A luminance ratio of the colors is simply expressed as follows considering a formula (the following formula (5)) of a luminance component Y in SDTV.

Wcom:ΔR:ΔB:ΔG=10:3:1:6

Y=0.299*R+0.587*G+0.114*B (5)

The subtraction sections 45R, 45G, and 45B subtract, in frames, the common white component Wcom extracted by the common portion extraction section 44 from the subsection-drive picture signals R, G and B, and thereby generate the differential signals (primary color components ΔR, ΔG, and ΔB) respectively. Specifically, the subtraction sections 45R, 45G, and 45B generate the differential signals (primary color components ΔR, ΔG, and ΔB) by using the following formulas (6) to (8). Such differential signals ΔR, ΔB, and ΔG are used to generate differential images of respective kinds of primary-color light (first differential images).

ΔR=R−Wcom (6)

ΔG=G−Wcom (7)

ΔB=B−Wcom (8)

The output signal selection switcher 46 selectively outputs images of the differential signals ΔR, ΔB, and ΔG outputted from the subtraction sections 45R, 45G, and 45B and an image of the common white component Wcom outputted from the common portion extraction section 44 to the display panel 2 as a plurality of field images. The images of the differential signals ΔR, ΔB, and ΔG correspond to an example of the “first differential images” of the invention, and the image of the common white component Wcom corresponds to an example of the “first common image” of the invention.

The backlight-color-light selection switcher 47 controls a light emission color and light emission timing of the backlight 3. Specifically, the backlight-color-light selection switcher 47 performs light emission control of selecting color light emitted from the backlight 3 such that the backlight appropriately emits light in synchronization with timing of a field image to be displayed (output timing of the output signal selection switcher 46) with color light necessary for the field image. More specifically, the backlight-color-light selection switcher 47 performs light emission control such that in a field period (first field period) where images of the differential signals ΔR, ΔG, and ΔB of the primary color components are selectively outputted, only corresponding primary-color light (red light, green light, or blue light) is emitted. In contrast, the backlight-color-light selection switcher 47 performs light emission control such that in a field period (second field period) where an image of the common white component Wcom is selectively outputted, the three kinds of primary-color light (red light, green light, and blue light) configuring the common white component Wcom are emitted together. Such light emission control is performed based on the light emission patterns BLr, BLg, and BLb outputted from the subsection-drive processing section 40, and an image pattern of the common white component Wcom outputted from the common portion extraction section 44. Specifically, the light emitting subsections 36 of the backlight 3 are turned on in accordance with a light emission pattern of (BLr+BLg+BLb) (see formula (12) described later).

### [Operation and Effects of Image Display Device 5]

Next, operation and effects of the image display device 5 will be described.

### [Basic Operation]

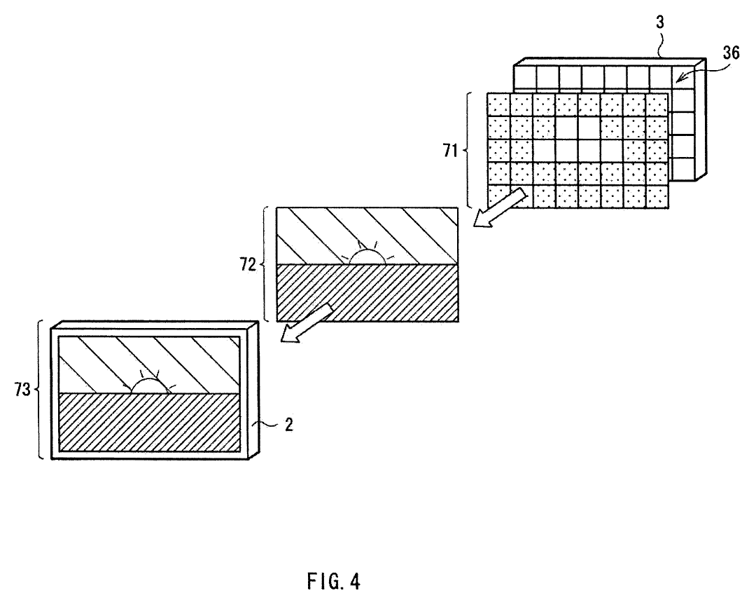

In the image display device 5, color light, which is emitted from the backlight 3 in units of the light emitting subsections 36, is modulated by the display panel 2, and thereby image display is performed based on the input picture signals (original signals Rorg, Gorg, and Borg), as shown in FIGS. 1 and 2. Specifically, for example, as shown in FIG. 4, a composite image 73 is finally observed, the composite image being given by physically superimposing (multiplicatively composing) a light emission surface image 71 by the light emitting subsections 36 of the backlight 3 and a panel surface image 72 singly given by the display panel 2.

At this time, the display control section 4 performs display control to the light emitting subsections 36 of the backlight 3 and the display panel 2, such that an input image is decomposed into a plurality of field images in frames, and the field images are time-dimensionally displayed by the field sequential method. That is, the field images are time-dimensionally displayed, so that each screen is changed at a rate too high for human eyes to recognize the screen by utilizing temporal resolution of human eyes. Thus, each color light is indiscriminative due to temporal color mixture based on a storage effect in a temporal direction of eyes, and consequently a color image is displayed using temporal color mixture.

### [Color Breaking Reduction Operation]

A basic principle of display of the field sequential method in the past is that each screen is changed at a rate too high for human eyes to recognize the screen by utilizing the temporal resolution of human eyes. However, RGB images being time-sequentially displayed are not well mixed due to complicated factors including limitation in optic nerves of an eye ball, and an image recognition sense of a human brain. As a result, when an image having low color purity such as a white image is displayed, or when tracking view is performed to a display object moving within a screen, each primary-color image is sometimes viewed as a residual image or the like, leading to a display phenomenon of color breaking causing extreme discomfort to a viewer. Such a color breaking phenomenon is roughly divided into two types of a color breaking phenomenon during displaying a still image, and a color breaking phenomenon during tracking view of a moving image as described before. The following display method according to the present embodiment has an effect of reducing both of the two kinds of color breaking phenomena.

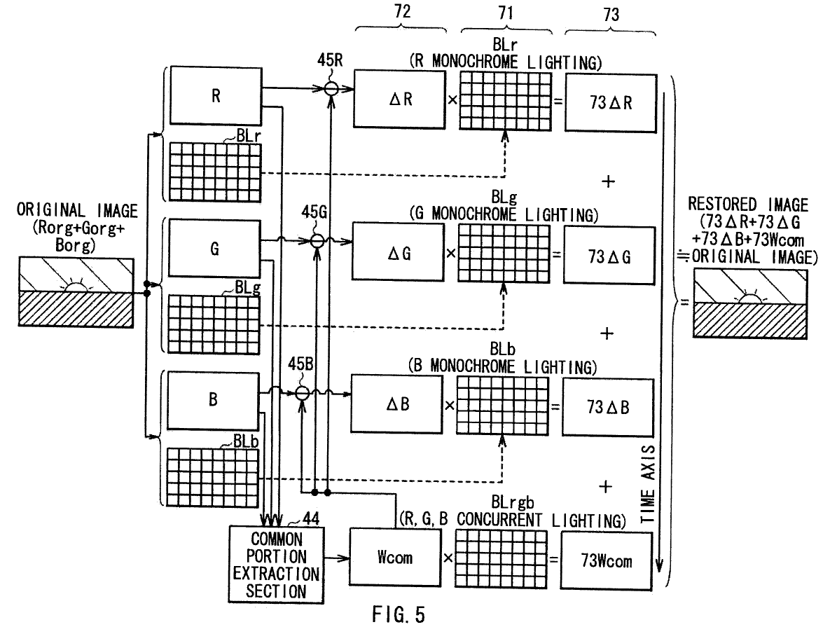

Thus, in the present embodiment, display operation is performed as shown in FIGS. 1 and 5 according to display control by the display control section 4. First, the resolution-lowering process section 41 in the subsection-drive processing section 40 performs resolution-lowering process to the original signals Rorg, Gorg, and Borg, and thereby generates the light emission patterns BLr, BLg, and BLb in units of the light emitting subsections 36 of the backlight 3. Moreover, the division sections 43R, 43G, and 43B in the subsection-drive processing section 40 divide signal levels of the original signals Rorg, Gorg, and Borg by signal levels of the light emission patterns BLr, BLg, and BLb, and thereby generates the subsection-drive picture signals R, G, and B respectively.

Next, the common portion extraction section 44 analyzes color components of subsection-drive images configured of the respective subsection-drive picture signals R, G, and B, and extracts the common white component Wcom common to all the three primary-color components from the subsection-drive images.

Next, the subtraction sections 45R, 45G, and 45B subtract, in frames, the common white component Wcom from the subsection-drive picture signals R, G, and B, and thereby generate the differential signals (primary color components ΔR, ΔB, and ΔG) respectively. The output signal selection switcher 46 selectively outputs images of the differential signals ΔR, ΔG, and ΔB of the respective primary-color components and an image of the common white component Wcom to the display panel 2 as a plurality of field images. Thereby, a panel surface image 72 (the images of the differential signals ΔR, ΔB, and ΔG and the image of the common white component Wcom) singly given by the display panel 2 is formed as shown in FIG. 5.

On the other hand, the backlight-color-light selection switcher 47 performs light emission control of selecting color light emitted from the backlight 3 in synchronization with output timing of the output signal selection switcher 46, based on the light emission patterns BLr, BLg, and BLb and the image pattern of the common white component Wcom. Specifically, as illustrated in FIG. 5, in a field period where images of the differential signals ΔR, ΔG, and ΔB of the primary color components are selectively outputted, the backlight-color-light selection switcher 47 performs light emission control such that only corresponding primary-color light (red light, green light, or blue light) is emitted. That is, in a field period where an image of the differential signal ΔR is outputted, the backlight-color-light selection switcher 47 performs light emission control such that monochrome light emission of red light is performed using the light emission pattern BLr of a red component. Similarly, in a field period where an image of the differential signal ΔG is outputted, the backlight-color-light selection switcher 47 performs light emission control such that monochrome light emission of green light is performed using the light emission pattern BLg of a green component. Also, in a field period where an image of the differential signal ΔB is outputted, the backlight-color-light selection switcher 47 performs light emission control such that monochrome light emission of blue light is performed using the light emission pattern BLb of a blue component. In contrast, in a field period where an image of the common white component Wcom is selectively outputted, the backlight-color-light selection switcher 47 performs light emission control such that the three kinds of primary-color light (red light, green light, and blue light) configuring the component Wcom are emitted together. That is, in the field period, the backlight-color-light selection switcher 47 performs light emission control such that the three kinds of primary-color light are emitted together using a light emission pattern BLrgb of the three primary-color components based on the image pattern of the common white component Wcom.

Since the following formulas (9) to (12) are derived using the formulas (1) to (4) and the formulas (9) to (12), the following can be said. First, in the field period where the images of the differential signals ΔR, ΔG, and ΔB of the respective primary color components is selectively outputted, field pictures 73ΔR, 73ΔG, and 73ΔB (corresponding to {(ΔR*BLr)+(ΔG*BLg)+(ΔB*BLb)} in formula (12)) are obtained. In the field period where the image of the common white component Wcom is selectively outputted, a field picture 73Wcom (corresponding to {Wcom*(BLr+BLg+BLb)} in the formula (12)) is obtained. Therefore, an original image principally corresponds to a restored image (visual image) as known from the formula (12).

$$\begin{matrix}Rorg = R * BLr = ( Δ R + Wcom ) * BLr & ( 9 ) \\ Gorg = G * BLg = ( Δ G + Wcom ) * BLg & ( 10 ) \\ Borg = B * BLb = ( Δ B + Wcom ) * BLb & ( 11 ) \\ \begin{matrix}Original image = Rorg + Gorg + Borg \\ = ( R * BLr ) + ( G * BLg ) + ( B * BLb ) \\ = \{ ( Δ R * BLr ) + ( Δ G * BLg ) + ( Δ B * BLb ) \} + \\ \{ Wcom * ( BLr + BLg + BLb ) \} \\ ≅ Restored image ( visual image )\end{matrix} & ( 12 )\end{matrix}$$

In this way, in the image display device 5, multiple (here, three) kinds of primary color light are emitted together so that multi-primary color display (three color display) is performed in the field period where the image of the common white component Wcom is selectively outputted. Each of the primary color lights is emitted from the backlight 3 in units of the light emitting subsections 36 having low resolution compared with display pixels. Thus, multi-primary color display with low color resolution is performed in the field period where the image of the common white component Wcom is selectively outputted.

On the other hand, in the field period where images of the differential signals ΔR, ΔG, and ΔB of the primary color components are selectively outputted, the images of the differential signals ΔR, ΔG, and ΔB are selectively outputted in a unit of each primary color component, the differential signals being given by subtracting the common white component Wcom from the subsection-drive images R, G, and B, respectively. Moreover, in the field period, only corresponding primary-color light is emitted from the backlight 3. Thus, luminance distribution of a display image along a time axis within a frame period tends to be concentrated (localized) in the field period where the image of the common white component Wcom is selectively outputted.

As hereinbefore, according to the present embodiment of the invention, in the field period where the image of the common white component Wcom is selectively outputted, the three kinds of primary color light are emitted together so that multi-primary color display is performed, and any of the primary color light is emitted from the backlight 3 in units of the light emitting subsections 36 having low resolution compared with display pixels. Accordingly, multi-primary color display (three color display) is performed with low resolution in the field period where the image of the common white component Wcom is selectively outputted. Also, in the field period where the images of the differential signals ΔR, ΔG, and ΔB of the primary color components are selectively outputted, the images of the differential signals ΔR, ΔG, and ΔB are selectively outputted in a unit of each primary color component, and only corresponding primary-color light is emitted from the backlight 3. Accordingly, luminance distribution of a display image along a time axis within a frame period is concentrated (localized) in the field period where the image of the common white component Wcom is selectively outputted. Therefore, color breaking occurring in the field sequential method is suppressed, leading to improvement in image quality in color display.

### 2. Second Embodiment

Next, a second embodiment of the invention will be described. In the present embodiment, the following common yellow component Yecom is used as the common color component instead of the common white component Wcom in the first embodiment. The same elements as in the first embodiment are marked with the same reference numerals or signs, and description of them is appropriately omitted.

### [General Configuration of Image Display Device 5A]

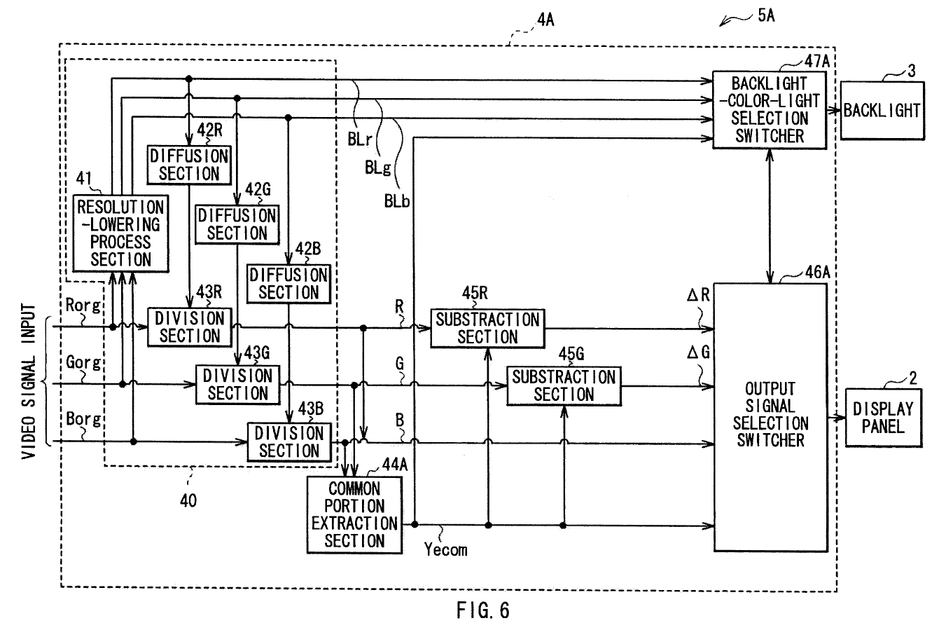

FIG. 6 shows a configuration example of an image display device 5A according to the present embodiment. The image display device 5A corresponds to the image display device 5 of the first embodiment, in which a display control section 4A is provided instead of the display control section 4. The display control section 4A has a common portion extraction section 44A, an output signal selection switcher 46A, and a backlight-color-light selection switcher 47A in place of the common portion extraction section 44, the output signal selection switcher 46, and the backlight-color-light selection switcher 47. The section 4A does not have the subtraction section 45B corresponding to a blue component, unlike the display control section 4.

The common portion extraction section 44A extracts a yellow component (common yellow component Yecom) common to a red component and a green component from subsection-drive picture signals R, G, and B. A color component W of an original image configured of original signals is expressed as the following formula (13) using the common yellow component Yecom, the red differential ΔR, the blue differential ΔB, and the green differential ΔG.

W=Yecom+ΔR+ΔB+ΔG (13)

A luminance ratio of the colors is expressed largely as follows considering the formula of the luminance component Y in SDTV.

Yecom:ΔR:ΔB:ΔG=9:3:1:6

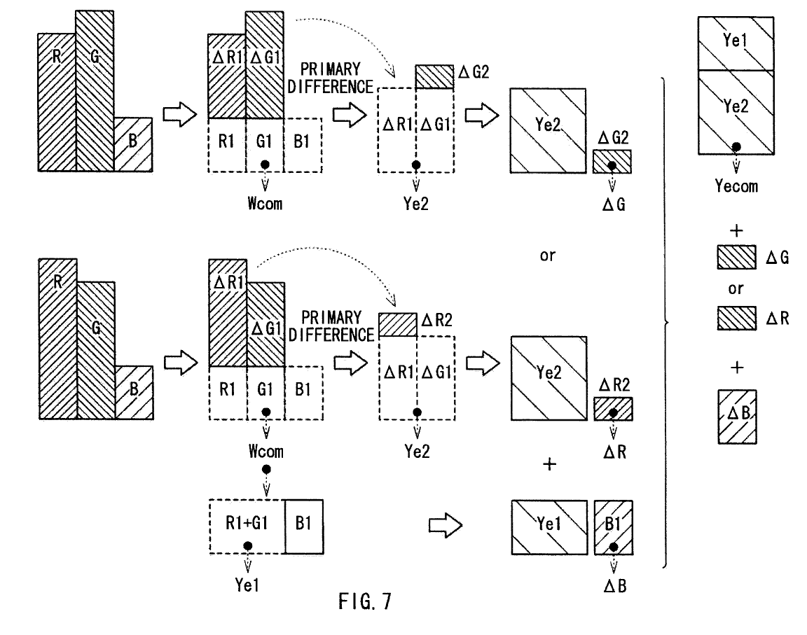

FIG. 7 schematically shows a first method of extracting the common yellow component Yecom from color signals R, G, and B. FIG. 7 collectively shows an extraction example in a first configuration example where a signal level is decreased in order of G, R, and B (upper side of the figure), and an extraction example in a second configuration example where a signal level is decreased in order of R, G, and B. In the first method, a white component Wcom is first extracted as a primary common portion (R1, G1, and B1). Then, R1 and G1 in the white component Wcom are separated into a first yellow component Ye1 and a blue component B1 respectively. Moreover, a second yellow component Ye2 is extracted as a secondary common portion of primary differential components (ΔR1 and ΔG1) after extracting the white component Wcom. Then, the extracted first and second yellow components Ye1 and Ye2 are added to be a final yellow component Yecom. A secondary differential component (ΔG2 or ΔR2) is left after extracting the second yellow component Ye2. Accordingly, in the first configuration example shown in the upper side, the color signals are finally separated into “Yecom+ΔG+ΔB” including the common yellow component Yecom and remaining components of green and blue. In the second configuration example, the color signals are finally separated into “Yecom+ΔR+ΔB” including the common yellow component Yecom and remaining components of red and blue.

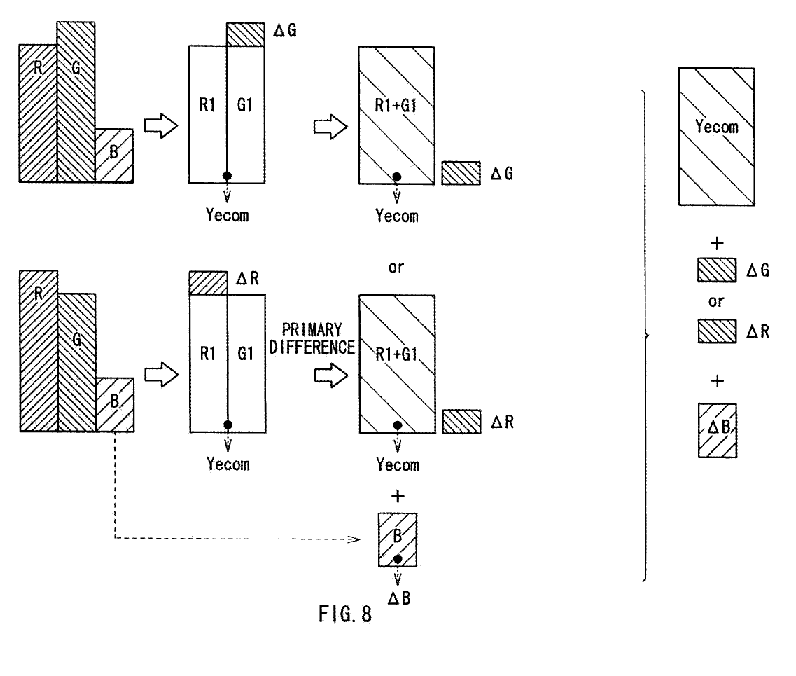

FIG. 8 schematically shows a second method of extracting the common yellow component Yecom from color signals of R, G, and B. In the first method in FIG. 7, the white component Wcom is temporarily extracted, and then the yellow component is extracted. However, in the second method, the common yellow component Yecom is directly extracted without extracting the white component Wcom. In the second method, primary differentials after extracting the common yellow component Yecom directly become final remaining components. Finally obtained components are the same as those in the case of FIG. 7.

The output signal selection switcher 46A selectively outputs images of the differential signals ΔR and ΔG outputted from the subtraction sections 45R and 45G an image of a subsection-drive picture signal B from the division section 43B, and an image of the common yellow component Yecom, to the display panel 2 as a plurality of field images.

In a field period where the images of the differential signals ΔR and ΔG of the two primary-color components and the image of the subsection-drive picture signal B are selectively outputted, the backlight-color-light selection switcher 47A performs light emission control such that only corresponding primary-color light (red light, green light, or blue light) is emitted. In contrast, in a field period where an image of the common yellow component Yecom is selectively outputted, the backlight-color-light selection switcher switcher 47A performs light emission control such that the two kinds of primary-color light (red light and green light) configuring the common yellow component Yecom are emitted together.

### [Operation and Effects of Image Display Device 5A]

Next, operation and effects of the image display device 5A will be described. Since basic operation of the image display device 5A is the same as that of the image display device 5 of the first embodiment, description of the operation is omitted.

### [Color Breaking Reduction Operation]

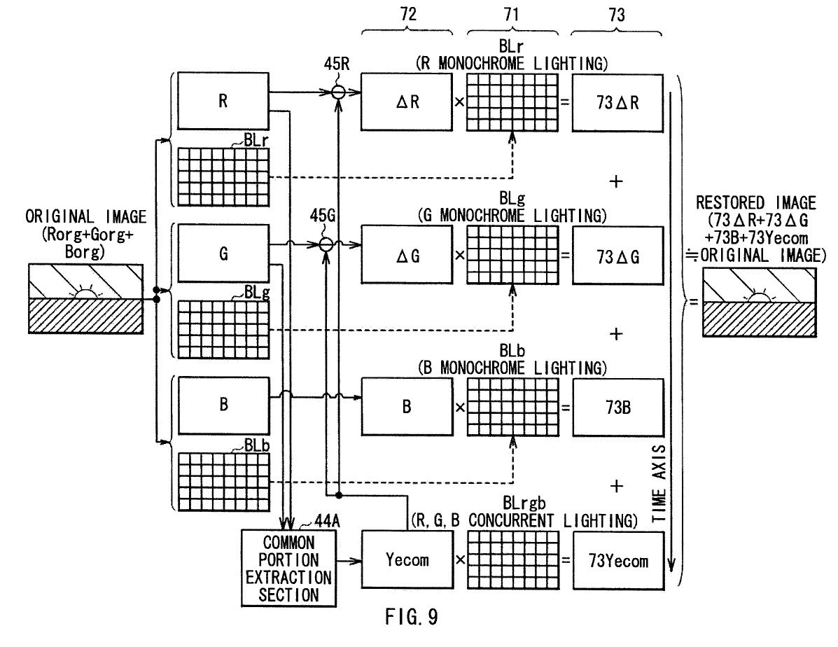

As illustrated in FIG. 9, in the image display device 5A, the two kinds of primary-color light (red light and green light) are emitted together so that multi-primary color display (two color display) is performed, in the field period where the image of the common yellow component Yecom is selectively outputted. Each of the primary color lights is emitted from the backlight 3 in units of light emitting subsections 36 having low resolution compared with display pixels. Thus, multi-primary color display is performed with low color resolution in the field period where the image of the common yellow component Yecom is selectively outputted.

On the other hand, in the field period where the images of the differential signals ΔR and ΔG and the image of the subsection-drive picture signal B are selectively outputted, the images of the differential signals ΔR and ΔG, which are given by subtracting the common yellow component Yecom from the subsection-drive images R and G respectively, and the image of the subsection-drive picture signal B, are selectively outputted. Moreover, in this field period, only the primary-color light corresponding thereto is emitted from the backlight 3. Thereby, luminance distribution of a display image along a time axis within a frame period tends to be concentrated (localized) in the field period where the image of the common yellow component Yecom is selectively outputted.

Therefore, the same effects as those in the first embodiment are obtained even in the present embodiment through the same operation. That is, color breaking occurring in the field sequential method is suppressed, leading to improvement in image quality in color display.

Also, in the present embodiment, the common yellow component Yecom is used instead of the common white component Wcom unlike the first embodiment. Thus, it can be said that the common yellow component Yecom is effective for reducing color breaking as compared with the common white component Wcom, as described below. This consideration is based on a known document (T. Hatada “Physiological Optics 10, Moving Image and Visual Characteristic”, O Plus E, 5(1985), 66, p 82 and FIG. 86). FIG. 86(b) of the document reveals a visual characteristic that as light is higher in luminance, or shorter in presentation time, the light is felt brighter to human eyes. FIG. 86(c) thereof reveals that apparent brightness of light is maximized in a temporal sequence depending on colors. Since the apparent brightness is maximized in order of red and green, yellow is inferred to be the middle of them. In addition, since yellow has high luminance compared with other monochromes, it is considered that yellow has a property of being felt brighter due to higher luminance as shown in FIG. 86(b). Therefore, it is considered that yellow has a property of being easily perceived prior to (quickly as compared with) white being a mixture of all the three primary-colors of RGB. Therefore, it can be inferred that perception sensitivity to a color of a moving picture is generally high and thus color breaking hardly occurs when an image utilizing yellow as a base (image of the common yellow component Yecom) is used as a reference, rather than using an image utilizing white as a base (image of the common white component Wcom).

In the present embodiment, the yellow component common to red and green components (common yellow component Yecom) has been used as an optional color component common to two primary-color components among the three primary-color components. However, this is not limitative. For example, another complementary color (magenta component Mg or cyan component Cy) may be easily separated as a common color component (common complementary color component) in the same way as in the example of FIG. 7 or 8. Therefore, the optional color component common to two primary-color components may be a cyan component common to green and blue components, or a magenta component common to blue and red components. In such a case, the color light selection section may select color light emitted from the backlight 3 such that both green light and blue light or both blue light and red light are emitted in a field period where an image of such a common color component is selectively outputted.

### [Modification of Second Embodiment: Modification 1]

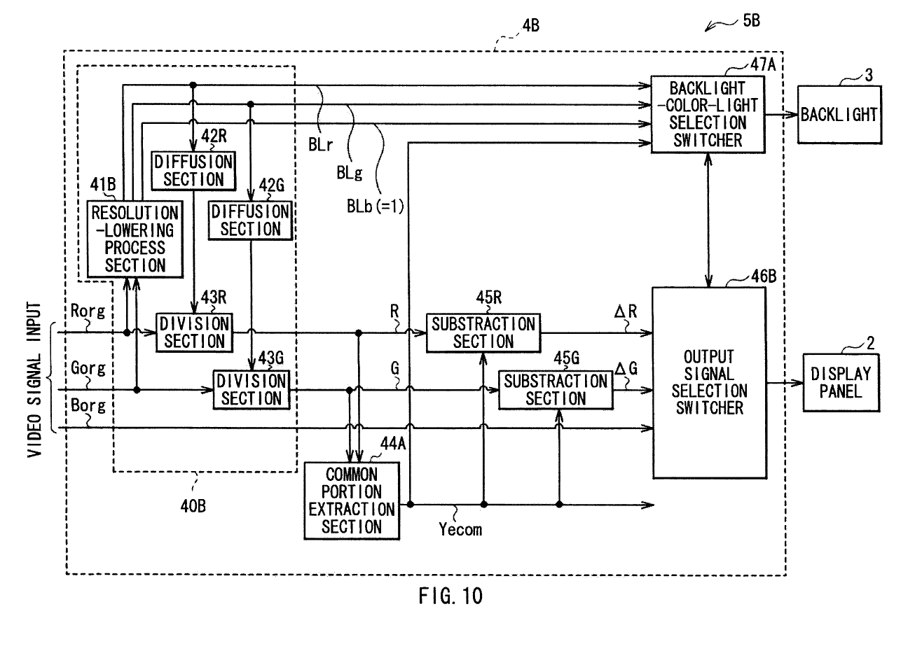

FIG. 10 shows a configuration example of an image display device 5B according to a modification of the second embodiment (modification 1). The image display device 5B corresponds to the image display device 5A of the second embodiment, in which a display control section 4B is provided instead of the display control section 4A. The display control section 4B has a subsection-drive processing section 40B and an output signal selection switcher 46B in place of the subsection-drive processing section 40 and the output signal selection switcher 46A.

The subsection-drive processing section 40B corresponds to the subsection-drive processing section 40 in which a resolution-lowering process section 41B is provided in place of the resolution-lowering process section 41, and a diffusion section 42B and a division section 43B, each section being corresponding to an original signal Borg, are not provided. That is, in a field period where an original image of a blue component configured of the original signal Borg is selectively outputted, all the light emitting subsections 36 of the backlight 3 are collectively controlled in light emission, and the subsection light emission control in units of the light emitting subsections 36, described hereinbefore, is not performed. Thus, the resolution-lowering process section 41B outputs a light emission pattern corresponding to the blue component as a fixed value of BLb=1.

The output signal selection switcher 46B selectively outputs images of the differential signals ΔR and ΔG outputted from the subtraction sections 45R and 45G, an original image configured of the original signal Borg, and an image of a common yellow component Yecom, to the display panel 2 as a plurality of field images.

In this way, as discussed with reference to the present modification, primary color components other than the common color component may not be subjected to subsection light emission control in units of the light emitting subsections 36.

### 3. Third Embodiment

Next, a third embodiment of the invention will be described. In the present embodiment, the display control method described in the first or second embodiment is performed, and in addition thereto, a display control section variably controls display order of a plurality of field images within a frame period in units of frames. The same elements as in the first and second embodiments are marked with the same reference numerals or signs, and description of them is appropriately omitted.

### [General Configuration of Image Display Device 5C]

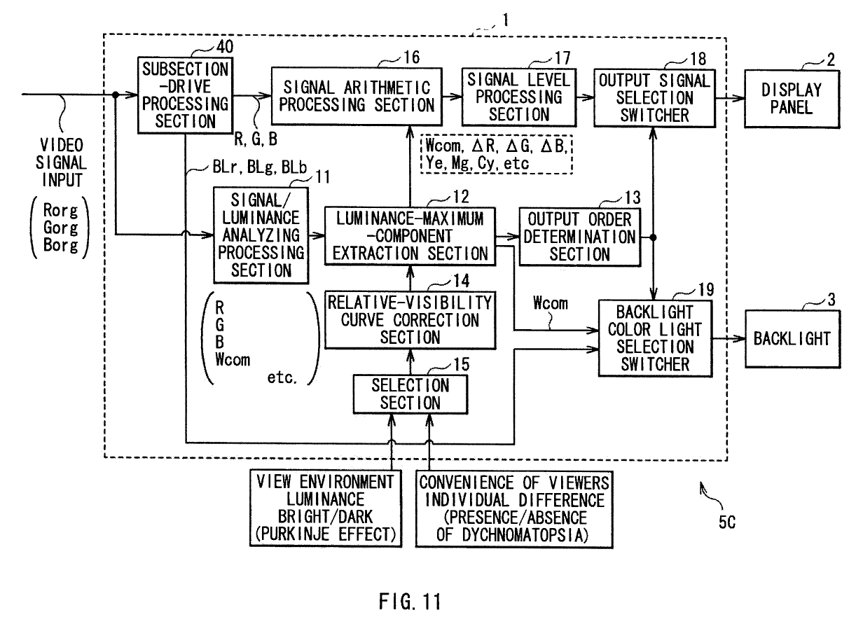

FIG. 11 shows a configuration example of an image display device 5C according to the present embodiment. The image display device 5C corresponds to the image display device 5 of the first embodiment, in which a display control section 1 is provided instead of the display control section 4.

### [Detailed Configuration of Display Control Section 1]

The display control section 1 decomposes an input image expressed by RGB picture signals into a plurality of field images in frames, and variably controls display order of the field images within a frame period in frames. The display control section 1 has the subsection-drive processing section 40 described in the first embodiment, a signal/luminance analyzing processing section 11, a luminance-maximum-component extraction section 12, an output order determination section 13, a relative-visibility curve correction section 14, and a selection section 15. Furthermore, the display control section 1 has a signal arithmetic processing section 16, a signal level processing section 17, an output signal selection switcher 18, and a backlight color light selection switcher 19.

In the present embodiment, the signal/luminance analyzing processing section 11 corresponds to an example of the “signal analysis section” of the invention. The signal/luminance analyzing processing section 11 and the luminance-maximum-component extraction section 12 correspond to an example of the “fundamental image determination section” of the invention. The signal arithmetic processing section 16, the signal level processing section 17, and the output signal selection switcher 18 correspond to an example of the “signal output section” of the invention. The output order determination section 13 corresponds to an example of the “output order determination section” of the invention.

The signal/luminance analyzing processing section 11 analyzes color components of an input image (original signals Rorg, Gorg, and Borg) in frames so as to obtain a signal level of each of a plurality of color component images in the case that the input image is decomposed into the color component images. While kinds of the decomposed color component images are described in detail later, the signal/luminance analyzing processing section 11 obtains a signal level of each of primary color images of a red component, a green component, and a blue component in the case that the input image is decomposed into only the primary color images as the plurality of color component images. Furthermore, the signal/luminance analyzing processing section 11 obtains a signal level of an image of another optional color component when the color component is extracted. While a specific example will be described later, for example, the signal/luminance analyzing processing section 11 obtains a signal level of a white component (common white component Wcom) as the signal level of another color component image in the case that the white component is extracted from the input image.

Moreover, the signal/luminance analyzing processing section 11 calculates a luminance level added with a visibility characteristic for each color component image, based on the obtained signal level of each color component image.

The luminance-maximum-component extraction section 12 determines a color component image having the highest luminance level or the second-highest luminance level as a fundamental image (a central image described later), based on the analysis result of the signal/luminance analyzing processing section 11. For example, a color component image is preferably selected as the fundamental image, in which when images of one frame are displayed on the display panel 2, composite luminance distribution on a retina of an observer is higher in luminance at the center of the distribution and lower in the periphery, and spreading range of the distribution is decreased to the utmost.

The signal/luminance analyzing processing section 11 and the luminance-maximum-component extraction section 12 selectively use a predetermined luminance transformation equation specified from a plurality of luminance transformation equations to calculate a luminance level. For example, a luminance component Y is expressed by the following equation in SDTV (* is a multiplication symbol). Strictly speaking, various transformation equations exist according to various standards. However, the embodiment uses the easy one for ease in understanding. In this luminance transformation equation, each of RGB primary-color signals is added with a typical visibility characteristic. When each of RGB primary-color signals is added with the typical visibility characteristic, the primary color signals are converted into a luminance ratio of about R:G:B=0.3:0.6:0.1.

Y=0.299*R+0.587*G+0.114*B (14)

As the luminance transformation equation, for example, a plurality of luminance transformation equations may be selectively used depending on view environment (light environment or dark environment). For example, at least two kinds of luminance transformation equations corresponding to photopic vision and scotopic vision may be selectively used depending on view environment (e.g., in accordance with Purkinje effect), as the luminance transformation equation. Alternatively, a plurality of luminance transformation equations may be selectively used depending on visual differences between individual observers (viewers). For example, at least two kinds of luminance transformation equations of an equation for a normal vision person and an equation for a color anomaly person may be selectively used. When view environment or presence of dyschromatopsia such as amblyopia is specified depending on preference of a viewer via the selection section 15, the luminance transformation equations are appropriately changed between them. When a luminance transformation equation is selected in correspondence to view environment, for example, brightness of the environment may be automatically detected by a brightness sensor so that an optimal luminance transformation equation is automatically selected depending on a result of the detection. The relative-visibility curve correction section 14 instructs the signal/luminance analyzing processing section 11 and the luminance-maximum-component extraction section 12 to select a luminance transformation equation in accordance with designation from the selection section 15.

The signal arithmetic processing section 16 and the signal level processing section 17 obtain a differential image by subtracting a color component of a fundamental image from an input image in frames, and decompose the differential image into a plurality of color components. Moreover, the signal arithmetic processing section 16 and the signal level processing section 17 divide the decomposed differential image of each color component into two so that a signal value is approximately halved.

The output signal selection switcher 18 selectively outputs the half-divided differential images of respective color components and a fundamental image to the display panel 2 as a plurality of field images.

The backlight color light selection switcher 19 controls an emission color and emission timing of the backlight 3. The backlight color light selection switcher 19 controls light emission of the backlight 3 such that the backlight 3 appropriately emits light in synchronization with display timing of a field image with color light necessary for the field image.

The output order determination section 13 controls output order of the plurality of field images to be outputted to the display panel 2 via the output signal selection switcher 18. Moreover, the output order determination section 13 controls emission order of emission colors of the backlight 3 via the backlight color light selection switcher 19. The output order determination section 13 controls the output order and the emission order such that the fundamental image is displayed in a temporally central position within a frame period. Moreover, the output order determination section 13 controls the output order and the emission order such that the half-divided differential images of respective color components are displayed temporally before and after the fundamental image in order of a higher luminance level added with a visible characteristic. In the case of luminance level added with a visible characteristic, for example, visibility is typically highest in green and lowest in blue among red, green, and blue.

### [Operation and Effects of Image Display Device 5C]

Next, operation and effects of the image display device 5C will be described in detail in comparison with a technique in the past.

[Display Method according to Existing Method]

Before describing operation (display method) of the image display device 5C, first, a display method by the field sequential method according to a technique in the past and difficulties thereof are described for comparison with such a technique. The following description is made assuming that a typical model is used in each of a color sense characteristic and view environment except for a particular case. It is assumed that, in the typical model, an observer is a normal color sense person, and an image is displayed in photopic vision environment.

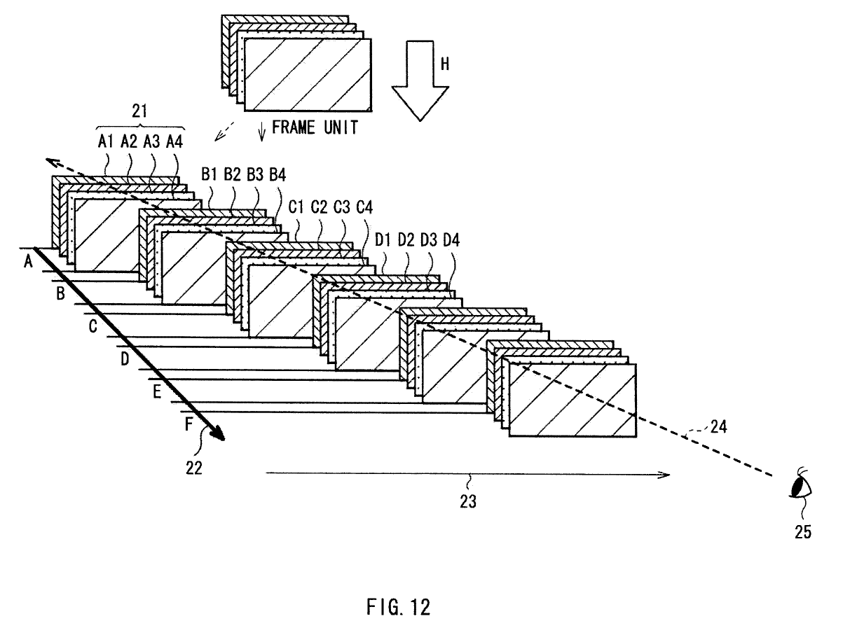

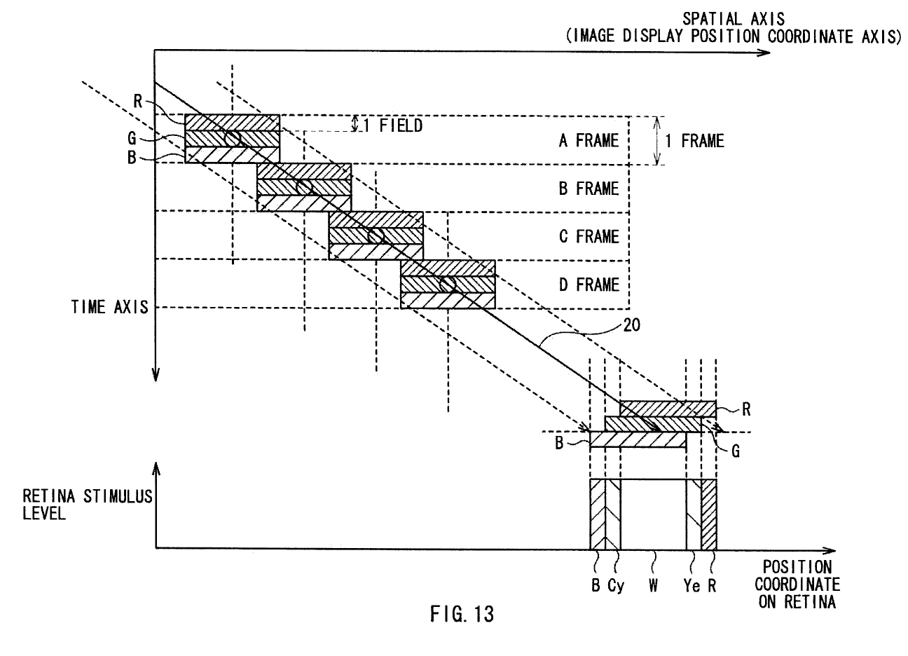

FIG. 12 shows a concept of image display by the field sequential method. In this display example, an image in a frame is decomposed into a plurality of color component images (field images). FIG. 12 is a time-space diagram showing an aspect where images in a frame spatially move to the right with time. In FIG. 12, frame images are shown in frame order of A, B, C, D etc. Each frame image is divided into subfields of four colors. For example, the frame A is configured as a frame unit of such a group that the frame is divided into subfields A1, A2, A3, and A4 of four colors. An arrow 22 shows time passing, an arrow 23 shows a spatial axis (image display position coordinate axis), and an arrow 24 shows the center of observation by an observer 25 (eye-tracking reference). Incidentally, such spatial representation using three-dimensional representation is not general, and representation is typically made using a plan view like FIG. 13 as viewed from above in an arrow H direction. Hereinafter, a representation form of FIG. 13 is used for description.

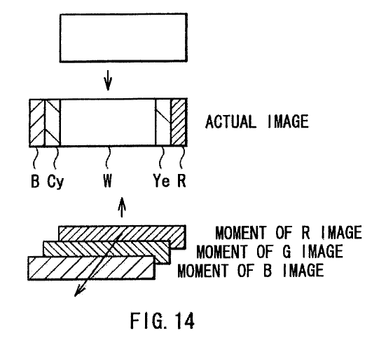

FIG. 13 shows an aspect where a frame image decomposed into RGB three fields move to the right by the field sequential method (upper side of the figure). Each field image is displayed in order of R, G, and B within a frame period. A tracking-view reference axis 20 is assumed to be in a central position of a G field image displayed in the center within a frame period. FIG. 13 further shows images superimposed during tracking view on a retina (luminance distribution on a retina) (lower side of the figure). In the case of FIG. 13, obvious color shift called the color breaking occurs in the front and the rear of the images in a moving direction. That is, when an image being originally white is moved to the right in a field configuration as shown in FIG. 13, an image which is actually seen is separated in color at lateral ends as shown in FIG. 14.

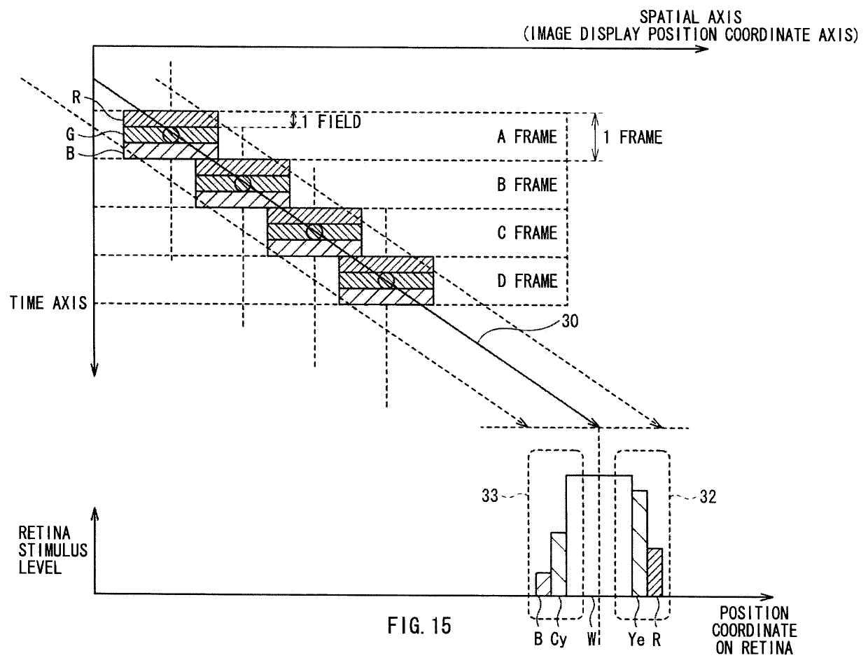

Incidentally, luminance distribution on a retina shown in the lower side of FIG. 13 is somewhat incorrect. Thus, FIG. 15 correctly shows the luminance distribution on a retina. While “retina stimulus level” is shown as a unit of a vertical axis, the retina stimulus level may be substantially similar to luminance after visibility processing. A luminance component Y is roughly expressed by the equation (14) in SDTV as described before. Therefore, although the luminance distribution is generally flat on a retina in FIG. 13, luminance level distribution is, to be precise, different between lateral two ends as shown in FIG. 15 when a visibility characteristic is additionally considered. That is, as shown in FIG. 15, luminance distribution is different between a right region 32 where shift in yellow component Ye and shift in red component R are perceived, and a left region 31 where shift in blue component B and shift in cyan component Cy are perceived. That is, luminance energy becomes irregular and uneven on a retina composite image.

In FIGS. 13 and 15, the tracking-view reference axis 20 or 30 is meaningfully drawn through image regions of a green component G highest in luminance in consideration of a visibility characteristic. Considering the visibility characteristic, luminance of other components including the red component R and the blue component B are relatively low. Since eyes unconsciously track the brightest image, the tracking-view reference axis is desirably set in a region relatively high in luminance. In a case of an image having no green component G, since the second brightest image in this case is a red component R image, a position of the tracking-view reference axis is close to the red component R. That is, what color is to be tracked by eyes (brain) matters.

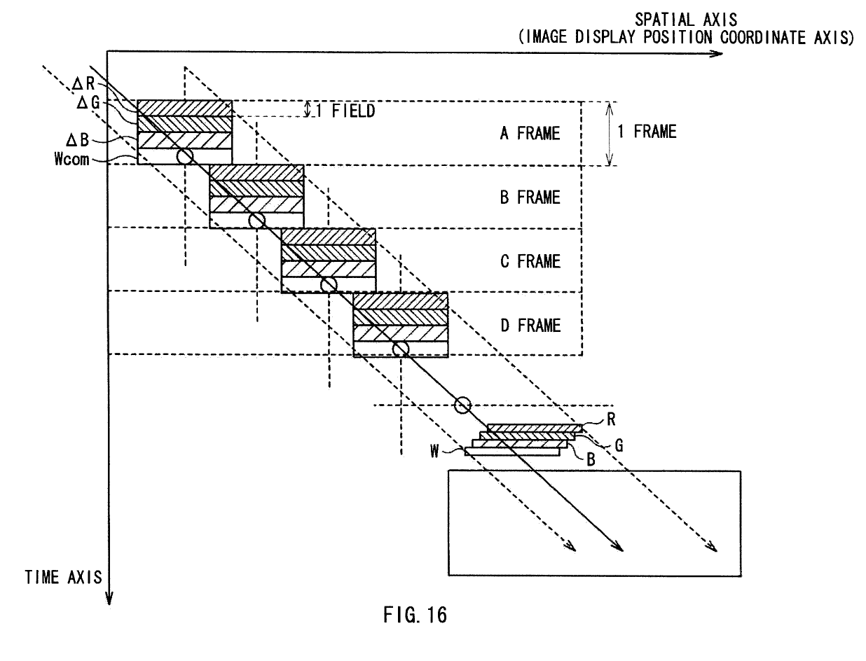

FIG. 16 shows a case where a common white component Wcom is extracted from an original image, and residual components are sorted into RGB, so that field images of four colors in total are used for display in the display example of FIGS. 13 and 15. Here, the common white component Wcom is defined as an OR set of levels of colors of the lowest level portions of respective RGB components within a frame image.

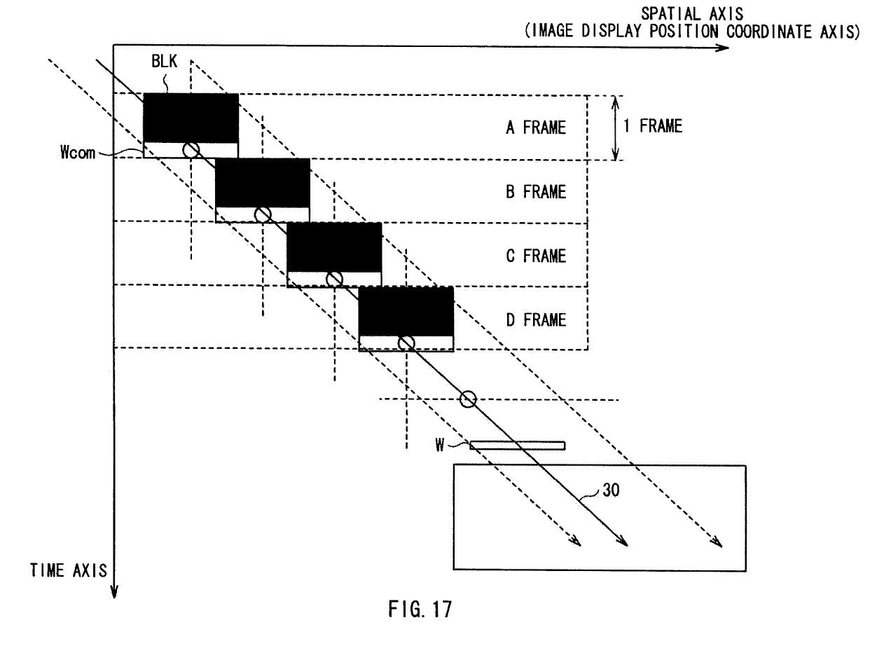

Description with reference to FIGS. 13 to 15 is made with an exemplified case where RGB field images are used to compose a frame image of W (white). This is typically called all-white image. On the other hand, in the method of FIG. 16, when a frame image of W (white) is displayed using the common white component Wcom, display will be, to be precise, as shown in FIG. 17. That is, as shown in FIG. 17, only the common white component Wcom is lit, and components of RGB are eliminated, leading to black display (BLK). While all the color components do not actually remain in the same positions on an image, residual RGB components ΔR, ΔG, and ΔB are assumed to exist for convenience of description in FIG. 16. Moreover, while the tracking-view reference axis 30 is drawn on a white field in FIG. 16, the tracking-view reference axis 30 is not necessarily formed in correspondence to the white field depending on luminance configurations of components of an image. The tracking-view reference axis 30 is drawn on the white field merely for convenience of description.

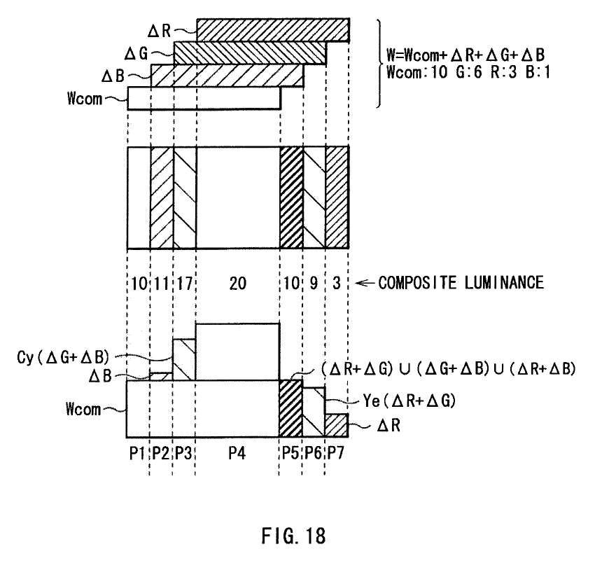

FIG. 18 shows luminance distribution on a retina in the case of the display example shown in FIG. 16. In FIG. 18, a color component W of an original image is expressed by the following equation using the common white component Wcom, a red differential ΔR, a blue differential ΔB, and a green differential ΔG.

W=Wcom+ΔR+ΔB+ΔG

A luminance ratio between respective colors is as follows in consideration of the equation of the luminance component Y.

Wcom:ΔR:ΔB:ΔG=10:3:1:6

In this case, composite luminance in each of areas P1 to P7 on a retina is expressed as follows.

P1:Wcom

P2:Wcom+ΔB

P3:Wcom+ΔB+ΔG

P4:W

P5:(ΔR+ΔG)∪(ΔG+ΔB)∪(ΔR+ΔB)

P6:ΔR+ΔG

P7:ΔR

A composite luminance value of each area calculated using the above is, for example, as follows:

P1=10, P2=11, P3=17, P4−20, P5=10, P6=9, and P7=3.

Since the common white component Wcom is extracted as in the examples of FIGS. 3A and 3B, one of colors is actually lost depending on a location within a screen of one frame. Accordingly, luminance distribution is, to be precise, not as shown in FIG. 18 at all local positions in an image. FIG. 18 shows an average state of all images. Thus, ΔR>0, ΔB>0, and ΔG>0 are not satisfied at the same time in the area P5 on a retina shown in FIG. 18 (components satisfying the three conditions at the same time are allowed to whiten, and therefore changed into the common white component Wcom). Consequently, the area P5 corresponds to an OR set component including any two colors added to each other in image distribution within a screen. As can be seen from luminance distribution of FIG. 18, according to the method of extracting the white component, since individual primary color components of RGB are attenuated, a color breaking situation is improved compared with the case of FIG. 15. However, color breaking is not perfectly suppressed.

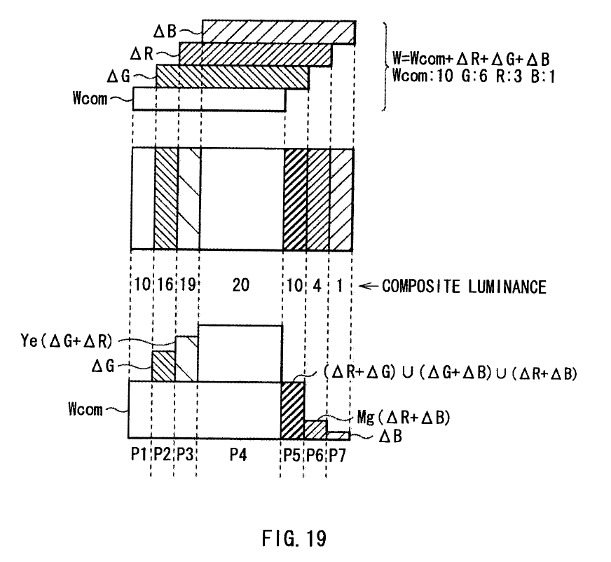

Next, FIG. 19 shows luminance distribution in a display example similar to the display example of FIG. 18. The display example of FIG. 19 is similar to the display example of FIG. 18 in that the common white component Wcom is used, but different in display order of residual components of RGB, i.e., ΔR, ΔG, and ΔB. Specifically, the residual components ΔR, ΔG, and ΔB are displayed in such a manner that the component having lower luminance (lower visibility) is temporally previously displayed, namely, displayed in order of a blue differential ΔB, a red differential ΔR, and a green differential ΔG. Finally, the common white component Wcom is displayed.

In the case of the display example of FIG. 19, composite luminance in each of areas P1 to P7 on a retina is expressed as follows.

P1:Wcom

P2:Wcom+ΔB

P3:Wcom+ΔB+ΔG

P4:W

P5:(ΔR+ΔG)∪(ΔG+ΔB)∪(ΔR+ΔB)

P6:ΔR+ΔG

P7:ΔR

A composite luminance value of each area calculated using the above is, for example, as follows:

P1=10, P2=16, P3=19, P4−20, P5=10, P6=4, and P7=1.

Incidentally, a luminance ratio between the colors is the same as in the case of FIG. 18.

In the display example of FIG. 19, the color components are displayed in lower luminance order, so that luminance energy is localized to a side of the common white component Wcom, leading to reduction in color breaking compared with the example shown in FIG. 18. However, color breaking is still not perfectly suppressed.

### [Display Method of the Present Embodiment]

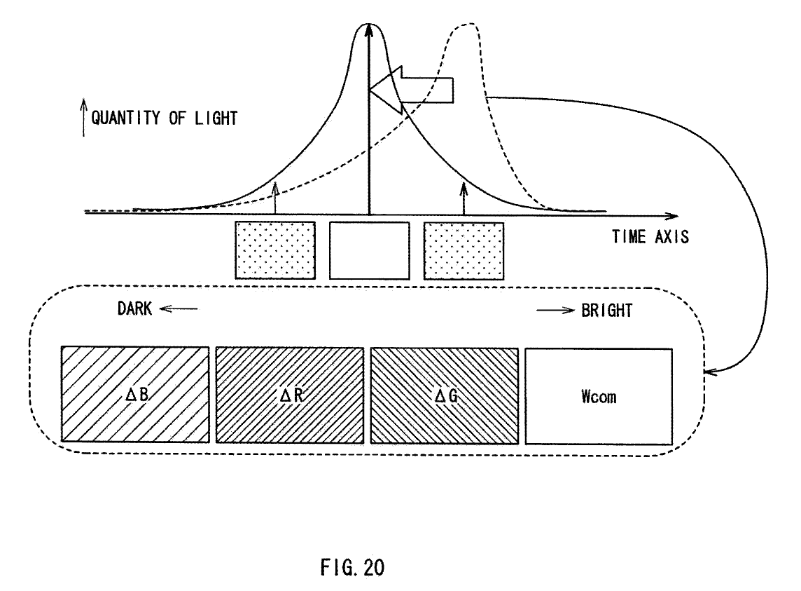

A display method according to the present embodiment will be described on the basis of the display method of the above technique in the past. In FIG. 20, a graph of the quantity of light shown by a broken line schematically shows distribution of the quantity of light within a frame period in the display example of FIG. 19. In the display example of FIG. 19, images are displayed in order from an image of a color component having the lowest luminance on a time axis within a frame period, and the common white component Wcom having the highest luminance is finally displayed. Therefore, luminance energy is localized to a side of the common white component Wcom, so that light quantity distribution (luminance distribution) is temporally asymmetric. If such light quantity distribution is changed to be high in luminance energy in the center and temporally symmetric as shown by a solid line in FIG. 20, color breaking is considered to be suppressed. The embodiment achieves such a display method.

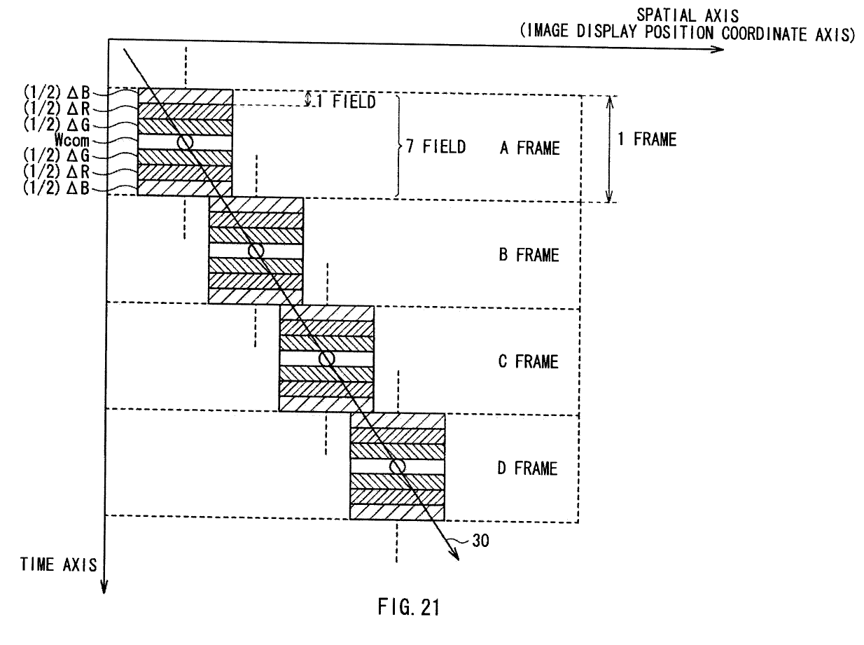

FIG. 21 shows an example of the display method, where the common white component Wcom is located in the center of fields, and color components, which are bright and high in visibility, are disposed near the center to the utmost within a frame period, and color components are generally symmetrically arranged. In this display example, the common white component Wcom is extracted from an original image, and the Wcom is displayed in the center within a frame period as a fundamental image. Moreover, differential components (1/2)ΔR, (1/2)ΔG and (1/2)ΔB are produced by halving residual components ΔR, ΔG, and ΔB, which are after the extraction of the common white component Wcom, so that each signal value is approximately halved respectively. The differential components are displayed temporally before and after the fundamental image in order of a higher luminance level added with a visibility characteristic. Specifically, the green differential (1/2)ΔG, the red differential (1/2)ΔR, and the blue differential (1/2)ΔB are temporally sequentially displayed in a temporally closer order to the common white component Wcom being the fundamental image (central image). In this display example, one frame is configured of seven field images in total including the common white component Wcom and the divided components (1/2)ΔR, (1/2)ΔG, and (1/2)ΔB. While the present embodiment describes an example where each of the residual components ΔR, ΔG, and ΔB is divided in two so that a signal value is perfectly halved, the signal value may not be perfectly halved. Signal levels may be somewhat different between half-divided color components in order to finally optimize luminance distribution on a retina.

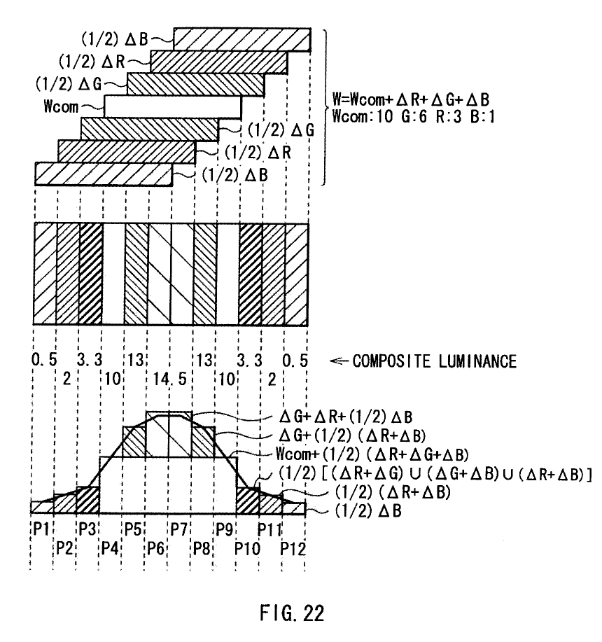

FIG. 22 shows luminance distribution on a retina in this display example. In FIG. 22, a color component W of an original image is expressed by the following equation using the common white component Wcom, a red differential ΔR, a blue differential ΔB, and a green differential ΔG.

W=Wcom+ΔR+ΔB+ΔG

A luminance ratio between the colors is as follows considering the equation of the luminance component Y.

Wcom:ΔR:ΔB:ΔG=10:3:1:6

In this case, composite luminance in each of areas P1 to P12 on a retina is expressed as follows.

P1:(1/2)ΔB

P2:(1/2)(ΔR+ΔB)

P3:(1/2)[(ΔR+ΔG)∪(ΔG+ΔB)∪(ΔR+ΔB)]

P4:Wcom+(1/2)(ΔR+ΔG+ΔB)

P5:Wcom+ΔG+(1/2)(ΔR+ΔB)

P6:Wcom+ΔG+ΔR+(1/2)ΔB

P7:Wcom+ΔG+ΔR+(1/2)ΔB

P8:Wcom+ΔG+(1/2)(ΔR+ΔB)

P9:Wcom+(1/2)(ΔR+ΔG+ΔB)

P10:(1/2)[(ΔR+ΔG)∪(ΔG+ΔB)∪(ΔR+ΔB)]

P11:(1/2)(ΔR+ΔB)

P12:(1/2)ΔB

A composite luminance value in each area calculated using the above is, [symbol] , as follows:

P1=0.5, P2=2, P3=3.3, P4=10, P5=13, P6, P7=14.5, P8=13, P9=10, P10=3.3, P11= [symbol] and P12=0.5.

Actually, the differential components (1/2)ΔR, (1/2)ΔG, and (1/2)ΔB are [symbol] low in signal level and in luminance level compared with a central image. While (1/2)ΔB is represented as 0.5 in a sense of schematically showing a shape of [symbol] distribution on a retina in FIG. 22, the value is shown for convenience of [symbol] As in the case of FIG. 18, as a result of extracting the common white [symbol] Wcom, a region where three primary-colors are not shown at the same time [symbol] the following luminance as average luminance in the case that any two colors are [symbol] from the three primary-colors.

z,999 1/2)*[(ΔR+ΔG)∪(ΔG+ΔB)∪(ΔR+ΔB)]=[(1.5+3)+(3+0.5)+(1.5+0.5)]/3=3.33

As shown in FIG. 22, in this display example, a luminance peak is located approximately in the center, and luminance distribution has a symmetrical shape.

As described hereinbefore, the present embodiment is capable of suppressing the color breaking occurring in tracking view of an moving image in the field sequential method. Specifically, barycenter distributing display is performed along a time axis about an image being bright and high in visibility as an eye-tracking reference, so that when movement display is performed, a slip amount is balanced on a retina, and thus is equalized with respect to the barycenter of the quantity of light. Thus, uneven color shift is made inconspicuous. Particularly, the display method according to the present embodiment uses no motion vector or no black insertion, while a method of correcting color shift during eye tracking by using a motion vector, or a method of reducing color breaking by inserting black has been used in the past. Nevertheless no motion error occurs in the display method. Also, in the past, it has been considered that when a plurality of mobile objects concurrently moving in different directions exist within one screen, a measure against color breaking may not be taken. In contrast, according to the display method of the present embodiment, even if an observer performs tracking view to any one mobile object, color breaking does not occur in display of another mobile object. Moreover, even if a movement direction is suddenly changed, since images are kept to be superimposed on a retina, color breaking does not occur.

Also, the display control methods described in the first and the second embodiments are combined, thereby another color is concurrently displayed on the barycenter image without degrading the function of performing barycenter distributing display sequentially along a time axis about an image being bright and high in visibility as an eye-tracking reference, so that when movement display is performed, a slip amount on a retina is further concentrically balanced, and thus is equalized with respect to the barycenter of the quantity of light, and consequently uneven slip is inconspicuous. Therefore, the color breaking is further reduced compared with the first and second embodiments.

Furthermore, the display method according to the present embodiment has another advantage that even if a high luminance image to be an eye-tracking reference is provided with a high resolution component, and low luminance images to be temporally symmetrically disposed are not provided with a high resolution component each, high resolution effect is perceived effectively.

Hereinafter, several modifications of the third embodiment are described. The same elements as in the third embodiment are marked with the same reference numerals or signs, and description of them is appropriately omitted.

### [Modification 2]

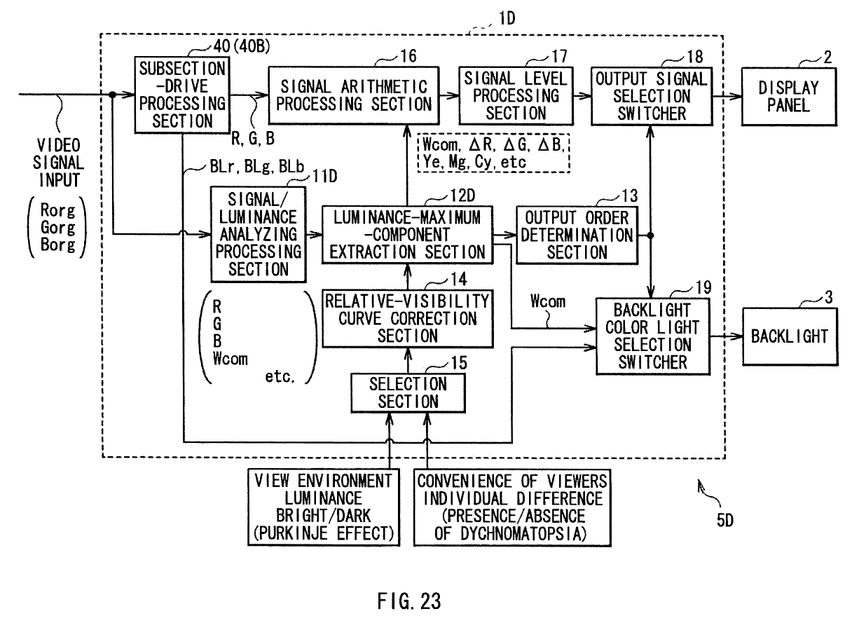

FIG. 23 shows a configuration example of an image display device 5D according to a modification of the third embodiment (modification 2). The image display device 5D corresponds to the image display device 5C of the third embodiment, in which a display control section 1D is provided instead of the display control section 1. The display control section 1D has the subsection-drive processing section 40 or the subsection-drive processing section 40B, and has a signal/luminance analyzing processing section 11D and a luminance-maximum-component extraction section 12D in place of the signal/luminance analyzing processing section 11 and the luminance-maximum-component extraction section 12.

The signal/luminance analyzing processing section 11D obtains, as a signal level of another color component image, a signal level of a complementary color component in the case of extracting a common complementary color component Xcom (for example, common yellow component Yecom) from an input image.

The luminance-maximum-component extraction section 12D is the same as the luminance-maximum-component extraction section 12, except that the common complementary color component Xcom is used in place of the common white component Wcom.

That is, in the present modification, a fundamental image (central image) is not limited to the common white component Wcom. A complementary color component or another optional color component may be extracted as a fundamental image.

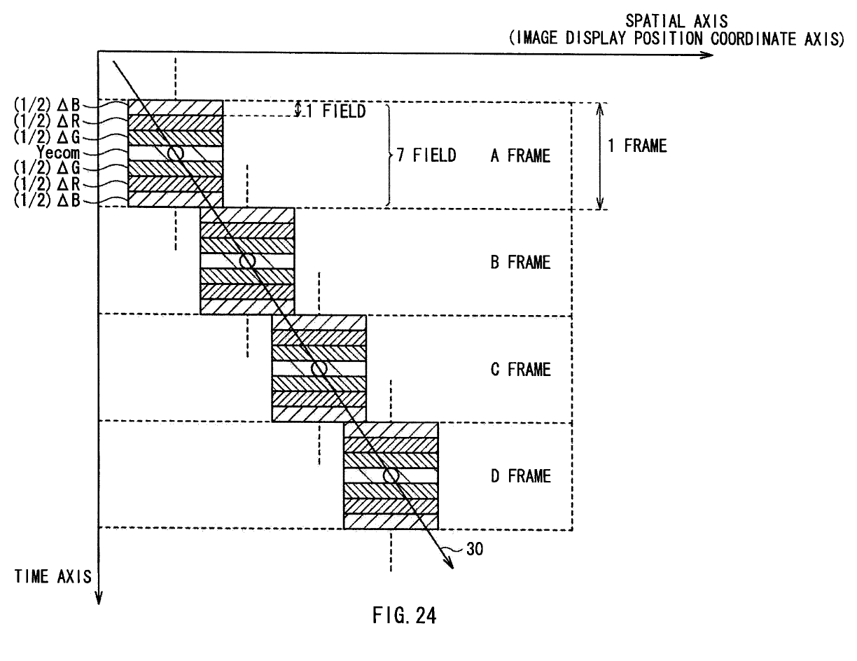

FIG. 24 shows a display example in the case that the common yellow component Yecom being a complementary color component is extracted as a fundamental image. This display example is basically the same as the display example of FIG. 21 described in the third embodiment, except that the common yellow component Yecom is displayed in a temporally central position in place of the common white component Wcom.

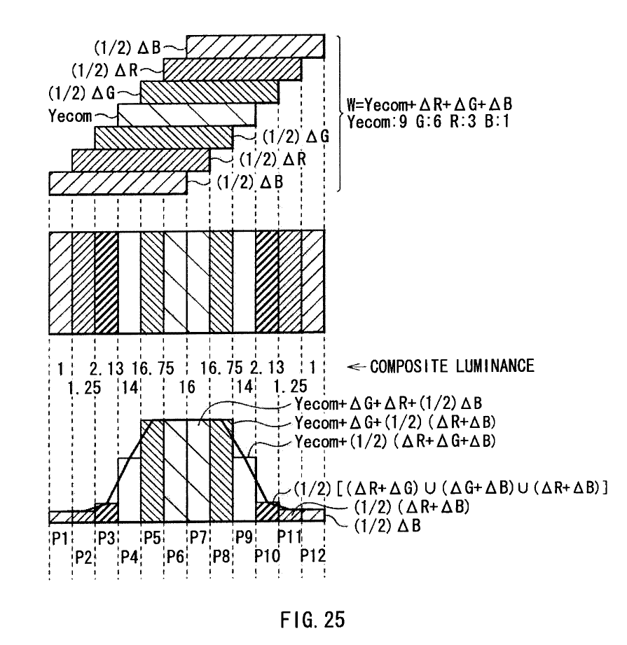

FIG. 25 shows luminance distribution on a retina in this display example. In FIG. 25, a color component W of an original image is expressed by the following equation using the common yellow component Yecom, a red differential ΔR, a blue differential ΔB, and a green differential ΔG.

W=Yecom+ΔR+ΔB+ΔG

A luminance ratio between the colors is as follows considering the equation of the luminance component Y.

Yecom:ΔR:ΔB:ΔG=9:3:1:6

In calculation of composite luminance, luminance distribution is appropriately corrected depending on an image configuration in order to cope with, for example, a phenomenon that a portion superimposed on the common yellow component Yecom is decreased in level of each of R and G, and increased in level of B (for example, by doubling a value of (1/2)ΔB).

In this case, composite luminance in each of areas P1 to P12 on a retina is expressed as follows.

P1:(1/2)ΔB

P2:(1/2)(ΔR+ΔB)

P3:(1/2)[(ΔR+ΔG)∪(ΔG+ΔB)∪(ΔR+ΔB)]

P4:Yecom+(1/2)(ΔR+ΔG+ΔB)

P5:Yecom+ΔG+(1/2)(ΔR+ΔB)

P6:Yecom+ΔG+ΔR+(1/2)ΔB

P7:Yecom+ΔG+ΔR+(1/2)ΔB

P8:Yecom+ΔG+(1/2)(ΔR+ΔB)

P9:Yecom+(1/2)(ΔR+ΔG+ΔB)

P10:(1/2)[(ΔR+ΔG)∪(ΔG+ΔB)∪(ΔR+ΔB)]

P11:(1/2)(ΔR+ΔB)

P12:(1/2)ΔB

A composite luminance value in each area calculated using the above is, for example, as follows:

P1=1, P2=1.25, P3=2.13, P4=14, P5=16.75, P6, P7=16, P8=16.75, P9=14, P10=2.13, P11=1.25, and P12=1.

The luminance values shown herein are merely values for convenience of description.

In this way, when an image is displayed with the common yellow component Yecom as the fundamental image, even if a signal level of the blue component B having low visibility is increased, luminance is not much increased. Moreover, the red component R and the green component G effectively contribute to display of the common yellow component Yecom compared with the blue component. These result in increase in luminance of the common yellow component Yecom being a temporally central image. In this display example, spreading of the luminance barycenter is effectively reduced in a temporal direction compared with a case where the common white component Wcom is displayed as shown in FIG. 22, leading to further reduction in color breaking.

### [Modification 3]

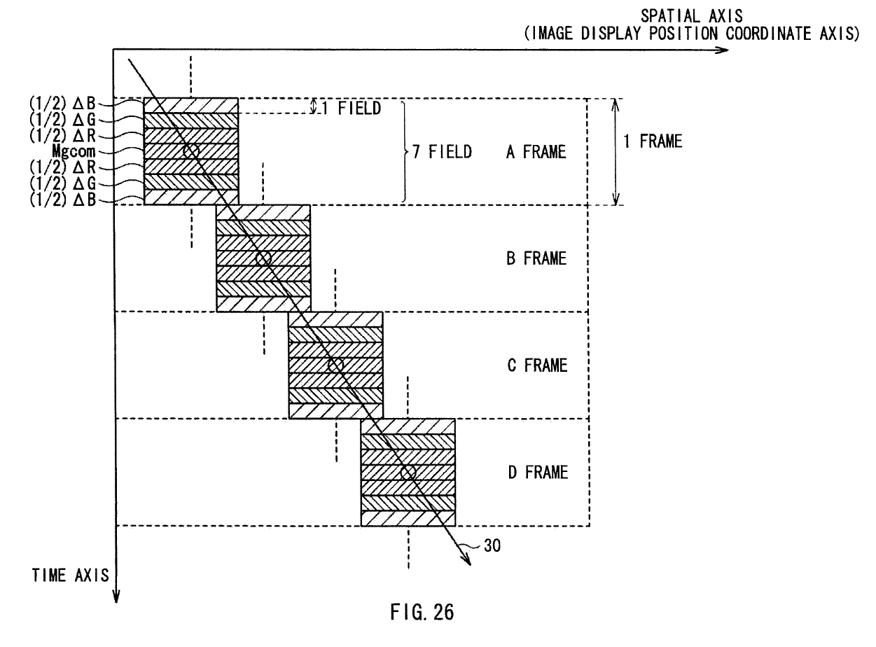

Another complementary color (magenta component Mg or cyan component Cy) is easily separated as a common complementary color component, as in the same way as the examples of FIGS. 23 to 25. FIG. 26 shows a display example in the case that the common magenta component Mgcom is set as a fundamental image. In this display example, a red differential (1/2) ΔR, a green differential (1/2) ΔG, and a blue differential (1/2) ΔB are temporally sequentially displayed in order of temporally closer to the common magenta component Mgcom.

### [Modification 4]

### [Method of Determining Color Component Disposed in Field Center]

In a typical image, a bright screen, from which a feature for eye tracking such as white or yellow is extractable, is not always continuously shown. The display method of the third embodiment is capable of addressing even such a case by determining a color component of a central image in the following way.

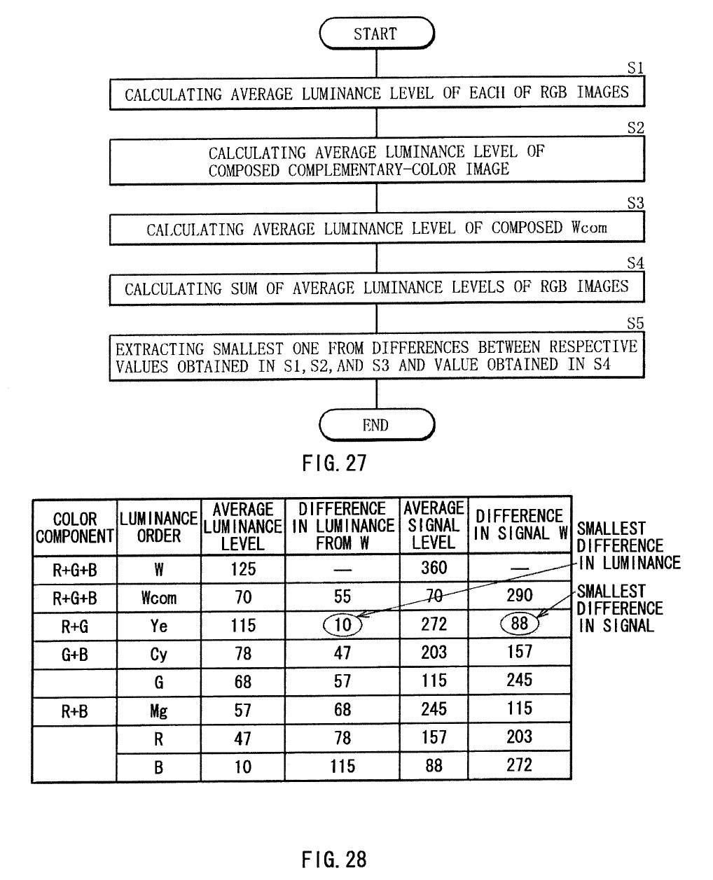

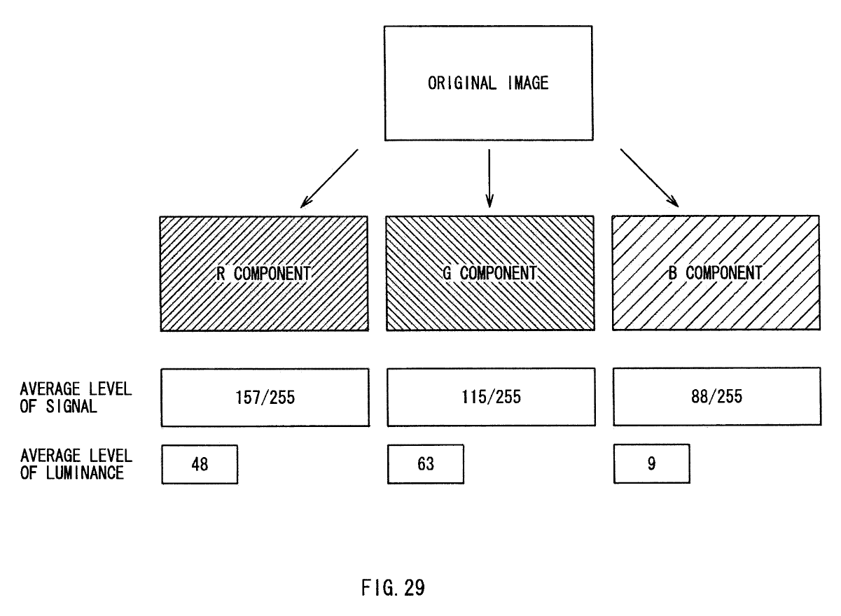

FIG. 27 shows an example of a method of determining a color component of a central image disposed in a field center according to modification 4. FIGS. 28 and 29 show a specific example of luminance values calculated in the processing therein. The processing is performed by the display control section 1 shown in FIG. 11 or the display control section 1D shown in FIG. 23. In particular, the processing is performed by the signal/luminance analyzing processing section 11 (or signal/luminance analyzing processing section 11D) and the luminance-maximum-component extraction section 12 (or luminance-maximum-component extraction section 12D).

The display control section 1 or the display control section 1D analyzes color components of an input image in frames, and obtains a signal level of each of a plurality of color component images in the case that the input image is decomposed into the color component images. Here, the display control section 1 or the display control section 1D obtains an average value within a screen of each color component. Specifically, the display control section 1 obtains an average of signal levels of each of primary color images of a red component, a green component, and a blue component in the case that an original image is decomposed into only the primary color images as shown in FIGS. 19 and 20. In addition, the display control section 1 obtains an average of signal levels of another optional color component when the color component is extracted. For example, the display control section 1 obtains an average of signal levels of a common white component as another color component in the case that the component Wcom is extracted. Moreover, for example, the display control section 1 obtains signal levels of a complementary color component (common yellow component Yecom or the like) in the case that the complementary color component is extracted.

The display control section 1 or the display control section 1D calculates an average luminance level of each of the primary color images of red, green, and blue components in frames based on the average values of the signal levels (step S1 of FIG. 27). In addition, the display control section 1 calculates an average luminance level of a complementary color component such as the common yellow component Yecom (step S2). Furthermore, the display control section 1 calculates an average luminance level of the common white component Wcom (step S3). Furthermore, the display control section 1 adds the average luminance levels of the primary color images of red, green, and blue, and thus obtains an average luminance level of a color component W of the original image as a whole (step S4). Finally, the display control section 1 obtains smallest one among differences between respective values of the average luminance levels of the colors obtained in the steps S1, S2, and S3, and the value of the average luminance level of the image as a whole (step S5).

A color component being smallest in difference obtained in this way is set as the fundamental image (central image). In the specific example of FIG. 28, since both of difference in average luminance level and difference in average signal level are smallest in the common yellow component Yecom, the common yellow component Yecom is set as the fundamental image.

Incidentally, since a fundamental image is determined by such processing, a color component other than the common white component Wcom and the common yellow component Yecom may be set as the fundamental image. Specifically, FIG. 26 shows a display example in the case that a common magenta component Mgcom is set as the fundamental image. Such a display example is given, for example, in the case that luminance distribution is configured such that the amount of green component is larger than the amount of blue component, but somewhat smaller than normal.

### [Modification 5]

### [Field Reduction Method]

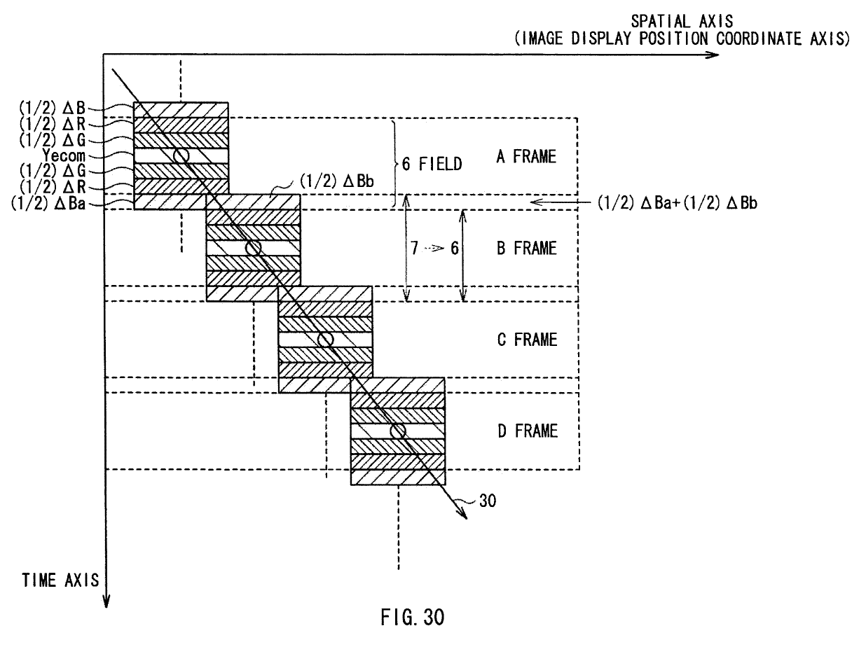

FIG. 30 shows a method of reducing the number of fields within a frame period while using the display method of the third embodiment. For example, when a display state as shown in FIG. 24 is given by using the display method of the third embodiment (modification 2), a blue component displayed in an outermost region within a frame is extremely reduced in luminance. By using this, for example, information of blue in each of successive frames A and B is shared by half by the frames, and the frames are simply added and composed to form an image. That is, when signal values of adjacent blue field images are (1/2)ΔBa and (1/2)ΔBb respectively, a composed value is as follows:

(1/2)ΔBa+(1/2)ΔBb

Such composed image is collectively displayed between adjacent frames. Thus, while the number of fields per frame is seven in the display state of FIG. 24, the number is decreased to six in the display state of FIG. 30. Such display is achieved through such control that the display control section 1 or the display control section 1D composes temporally adjacent two field images between temporally adjacent, first and second frames so that the field images are collectively displayed within a field period.

### [Modification 6]

[Display Method with Visibility Correction]

Hereinbefore, the display method of the third embodiment has been described with a color sense characteristic and view environment assumed as a typical model each. However, visibility correction may be made in consideration of difference in individual (personal) color sense characteristic or difference in view environment. This visibility correction is achieved by appropriately modifying the luminance transformation equation used in the signal/luminance analyzing processing section 11 or 11D and the luminance-maximum-component extraction section 12 or 12D.

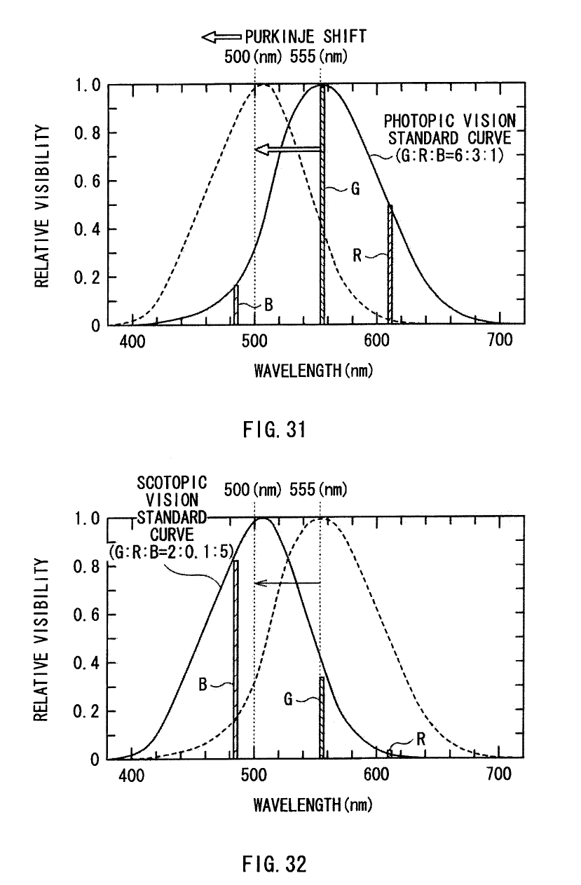

FIG. 31 shows a human visibility characteristic in a light place (photopic vision). FIG. 32 shows a human visibility characteristic in a dark place (scotopic vision). In photopic vision, the human visible characteristic has relative visibility having the largest peak at 555 nm as shown in FIG. 31. In this case, a sensitivity ratio between the primary colors R, G, and B is approximately R:G:B=3:6:1. In a typical TV standard, the luminance component Y is approximately expressed by the following equation with the sensitivity ratio being added.

Y=0.3R+0.6G+0.1B

On the other hand, in scotopic vision where Purkinje shift occurs, the human visible characteristic has relative visibility having the largest peak shifted to a region near 500 nm as shown in FIG. 32. In this case, a sensitivity ratio between the primary colors R, G, and B is approximately R:G:B=0.1:2:5. Therefore, the luminance transformation equation used in the signal/luminance analyzing processing section 11 and the luminance-maximum-component extraction section 12 is modified into the following equation:

Y=0.1R+2G+5B

Thus, a fundamental image optimum for scotopic vision is extracted, leading to display optimum for scotopic vision. In actual use, such sensitivity shift of the wavelength occurs in luminance of extremely dark, special environment where darkness is too deep to distinguish colors. Therefore, such visibility correction is preferably performed only in a case of an extremely dark display screen in extremely dark environment.

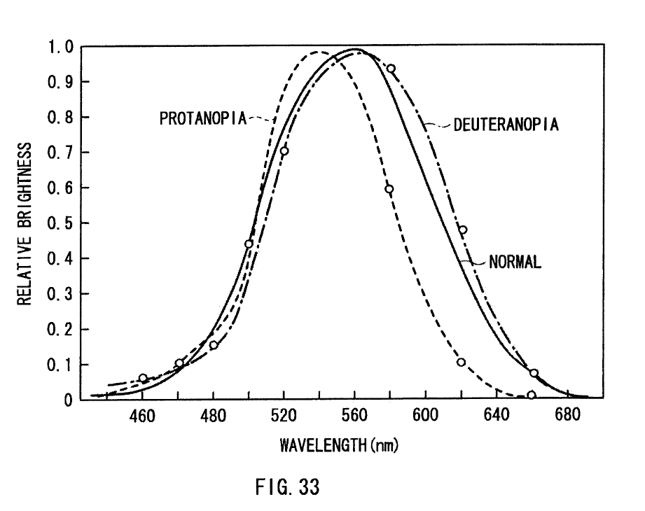

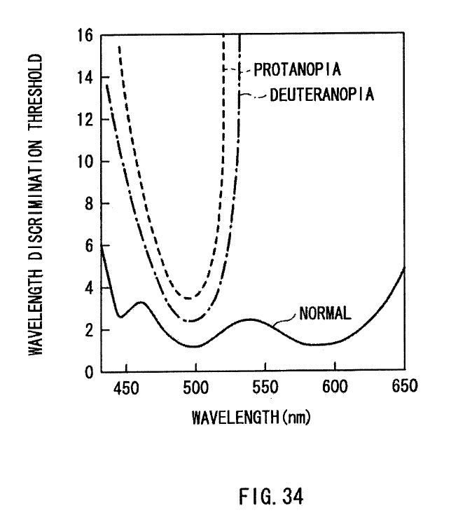

FIG. 33 shows a visibility characteristic of a person having dyschromatopsia (protanopia or deuteranopia) in comparison with that of a normal person. FIG. 34 shows a wavelength-discriminating characteristic of a person having color anomaly in comparison with that of a normal person. As can be seen from FIG. 33, a person with protanopia feels a red region to be dark compared with the normal person. As can be seen from FIG. 34, a person with protanopia and a person with deuteranopia hardly perform wavelength discrimination on a long wavelength side compared with the normal person. By using a luminance transformation equation in accordance with a visibility characteristic of such typical color anomaly, an optimum fundamental image is extracted in accordance with difference in individual vision characteristic, leading to optimum display for individuals.

### [Other Modifications]

While the invention has been described with several embodiments and modifications, the invention is not limited to the embodiments and the like, and may be variously modified or altered.

For example, in the third embodiment, a field rate is fixed to, for example, 360 Hz, and field periods may be equal to one another within a frame period, or a field rate may be varied within a frame period. For example, only a central image on a time axis and field images on both sides of the central image may be displayed with a field period of 1/360 sec while displaying field images disposed on still outer sides with 1/240 sec. That is, a field rate may be varied within a frame period as long as field images other than a central image are temporally symmetrically disposed on a time axis with respect to the central imager. Even in this case, since luminance distribution on a retina finally becomes symmetric, an effect of suppressing color breaking is provided.

Furthermore, while the third embodiment has been described with a case where a color component image finally specified based on a luminance level is always set as a central image, a color component set for the central image may be changed within a range where luminance distribution is not significantly affected. For example, it can be considered that, while yellow is best choice for the central image when the central image is determined based on a luminance level, white is the best choice for the central image when the central image is determined based on a signal level. It is further considered that even if the central image is determined only based on a luminance level, a significant difference does not exist in luminance level, for example, between yellow and white. In such a case, for example, an image being set as the central image may be changed in optional frames between a color component having the highest luminance level (for example, yellow) and a color component having the second highest luminance level (for example, white). For example, a frame image including “BRGWGRB” and a frame image including “BRGYeGRB” may be optionally mixed and displayed on a time axis.

The present application contains subject matter related to that disclosed in Japanese Priority Patent Application JP 2009-099177 filed in the Japan Patent Office on Apr. 15, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalent thereof.

What is claimed is:

1. An image display device comprising:
a light source section having a plurality of light emitting subsections configured to be controlled independently of each other, each of the light emitting subsections emitting multiple kinds of color light;
a display panel modulating color light emitted from the light source section based on an input picture signal; and
a display control section controlling the light emitting subsections of the light source section and the display panel, so that an input frame image configured of the input picture signal is decomposed into a plurality of field images, and so that the plurality of field images are time-divisionally displayed in a field sequential manner,
wherein the display control section includes
a subsection-drive processing section applying a predetermined resolution-lowering process on the input picture signal, thereby generating a light emission pattern based on a result of the resolution-lowering process, the light emission pattern being to be formed through selective light emitting operations of the plurality of light emitting subsections of the light source section, and then the subsection-drive processing section performing a dividing operation in which a signal level of each pixel signal in the input picture signal is divided by an emission-level of corresponding light emitting subsection in the light emission pattern, thereby generating a subsection-drive picture signal as a result of the dividing operation,
a signal analysis section analyzing color components of a subsection-drive frame image configured of the subsection-drive picture signal, to extract a first common luminance portion from the subsection-drive frame image, the first common luminance portion having a luminance magnitude common to two or more of three primary-color components configured of red, green, and blue components,
a signal output section obtaining a first differential image for each of the three primary-color components by subtracting the first common luminance portion from the subsection-drive frame image, and sequentially outputting, as the plurality of field images, the first differential images for the primary-color components and a first common image which is configured of the first common luminance portion to the display panel in a time-divisional manner, and
a color light selection section selecting color light to be emitted from the light source section based on the light emission pattern and the first common image, so that, in each of first field periods where the first differential images for the primary color components are outputted respectively, only corresponding primary color light is emitted, and in a second field period where the first common image is outputted, multiple kinds of primary color light, corresponding to the two or more primary-color components which configure the first common luminance portion, are emitted together.

2. The image display device according to claim 1, wherein
the first common luminance portion is a portion having a luminance magnitude common to any two of the three primary-color components, and
the color light selection section selecting the color light emitted from the light source section, so that two kinds of primary color light, which corresponds to the two of the three primary-color components respectively, are emitted together in the second field period.

3. The image display device according to claim 2, wherein
the first common luminance portion is a portion having a luminance magnitude common to red and green components, which corresponds to a yellow component, and
the color light selection section selecting the color light emitted from the light source section, so that red light and green light are emitted together in the second field period.

4. The image display device according to claim 2, wherein
the signal output section outputs, in another field period, a field image which corresponds to a primary color component other than the two of the three primary-color components, and
the color light selection section selects and controls all the light emitting subsections in the light source section to emit light in the another field period.

5. The image display device according to claim 1,
wherein the first common luminance portion is a portion having a luminance magnitude common to all the three primary-color components, which corresponds to a white component, and
the color light selection section selecting the color light emitted from the light source section, so that the three kinds of primary color light configured of red, green and blue light are emitted together in the second field period.

6. The image display device according to claim 1, wherein
the signal analysis section analyzes color components of the input frame image, thereby obtains a signal level of each of a plurality of color component images which are obtained through decomposing the input frame image into a plurality of color components,
the display control section further includes a fundamental-image determination section calculating a luminance level with consideration of a visibility characteristic for each of the color component images based on a signal level of each of the color component images obtained by the signal analysis section, and then determining a color component image, having the highest luminance level or the second highest luminance level, as a fundamental image,
the signal output section further performs processes of obtaining a second differential image for each of the plurality of color components by subtracting the fundamental image from the subsection-drive frame image, halving the second differential image obtained for each of the color components, and then sequentially outputting halved images for each of the color components as well as the fundamental image, as the plurality of field images, to the display panel in a time-divisional manner, and
the display control section further includes an output sequence determination section controlling output sequence in a frame of the plurality of field images outputted from the signal output section so that the fundamental image is displayed in a temporally central position within a frame period, and so that the halved images are displayed before and after the fundamental image in such a manner that a halved image having a higher luminance level with consideration of the visibility characteristic is located closer to the fundamental image.

7. The image display device according to claim 6, wherein
the fundamental image determination section determines a color component image as the fundamental image, which satisfies such a condition that, when the plurality of color component images corresponding to one frame are displayed on the display panel, composite luminance distribution on a retina of an observer has high luminance at center and low luminance in periphery, and a spreading range of the composite luminance distribution is minimized.

8. The image display device according to claim 6, wherein
the signal analysis section obtains a signal level of each of three primary-color components images which are obtained through decomposing the input frame image into only the three primary-color component, and signal levels of another color component images which are obtained through extracting another optional color components from the input frame image.

9. The image display device according to claim 8, wherein
the signal analysis section obtains at least signal levels of a white component image and a complementary color component image as the signal levels of another color component images, the white component image and the complementary color component being obtained through extracting a white component and a complementary color component from the input frame image, respectively.

10. The image display device according to claim 6, wherein
the fundamental-image determination section calculates the luminance level with use of luminance transformation expressions selected from a plurality of luminance transformation expressions.

11. The image display device according to claim 10, wherein
the fundamental-image determination section selectively uses at least two kinds of luminance transformation expressions applicable to photopic vision and scotopic vision, respectively, as the luminance transformation.

12. The image display device according to claim 10, wherein
the fundamental-image determination section selectively uses at least two kinds of luminance transformations expressions applicable to a person with normal color vision and a color deviant, respectively, as the luminance transformation.

13. The image display device according to claim 6, wherein
the display control section forms a composite field image from adjacent two field images, and displays the composite field image within a field period, one of the two field images belonging to a first frame and another belonging to second frame which is adjacent to first frame.

14. The image display device according to claim 6, wherein
the signal analysis section further extracts a second common luminance portion from the input frame image, the second common luminance portion having a luminance magnitude common to two or more of the three primary-color components, and
the fundamental-image determination section determines, as the fundamental image, a second common image configured of the second common luminance portion.
